(19) United States
(12) Patent Application Publication
(10) Pub. No.: US 2007/0088508 A1
(43) Pub. Date: Apr. 19, 2007

(54) Cocrystallization methods

(76) Inventor: Scott Childs, Atlanta, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/527,395

(22) Filed: Sep. 27, 2006

Related U.S. Application Data
(60) Provisional application No. 60/721,115, filed on Sep. 28, 2005.

(51) Int. Cl. G06F 19/00

(52) U.S. Cl. 702/19

(57) ABSTRACT

Methods for preparing cocrystals wherein solutions of active agents in suitable liquids are combined with solutions of guests, both with and without suitable liquids, in an interface region are described herein. Methods for analyzing the cocrystals are also described.

This application claims the benefit of priority to provisional application No. 60/721,115, filed on Sep. 28, 2005, the contents of which are incorporated by reference herein.

Cocrystals are crystals that contain two or more non-identical molecules. Examples of cocrystals may be found in the Cambridge Structural Database. Examples of cocrystals may also be found at Etter, Margaret C., and Daniel A. Adsmond (1990) “The use of cocrystallization as a method of studying hydrogen bond preferences of 2-aminopyridine” J. Chem. Soc., Chem. Commun. 1990 589-59 1, Etter, Margaret C., John C. MacDonald, and Joel Bernstein (1990a) “Graph-set analysis of hydrogen-bond patterns in organic crystals” Acta Crystallogr., Sect. B, Struct. Sci. B46 256-262, Etter, Margaret C., Zofia Urba\ddot{n}czyk-Lipkowska, Mohammad Zia-Ebrahimi, and Thomas W. Panunto (1990b) “Hydrogen bond directed cocrystallization and molecular recognition properties of diarylureas” J. Am. Chem. Soc. 112 8415-8426, which are incorporated herein by reference in their entireties. The following articles are also incorporated herein by reference in their entireties: Carl Henrik Görbotz and Hans-Petter Hersieth, 2000, “On the inclusion of solvent molecules in the crystal structures of organic compounds” Acta Cryst. (2000), B56, 625-534; and V. S. Senthil Kumar, Ashwini Nangia, Amy K. Katz and H. L. Carrell, 2002, “Molecular Complexes of Some Mono- and Dicarboxylic Acids with trans-1,4,-Dithiane-1,4-dioxide” American Chemical Society, Crystal Growth & Design, Vol. 2, No. 4, 2002.

By cocrystallizing an active agent with a guest, one can create new solid state phases which may have improved properties over existing solid state phases of that active agent. For example, new drug formulations comprising cocrystals of active pharmaceutical ingredients (APIs) with pharmaceutically acceptable guests may have superior properties over existing drug formulations. The active agent and guest will vary depending on the industry. For example, in the pharmaceutical field, the active agent may be an API, and the other component of the cocrystal (the guest) must be a pharmaceutically acceptable compound (which could also be an API). Active agents and guests may also include nutraceuticals, agricultural chemicals, pigments, dyes, explosives, polymer additives, lubricant additives, photographic chemicals, and structural and electronic materials.

The methods of the disclosure may be employed to generate a wide variety of cocrystals of active agents and guests. For example, the methods of the disclosure may be used to generate cocrystals of a salt of an active agent, such as a salt of an active pharmaceutical ingredient, with a neutral guest. Alternatively, a cocrystal of a neutral or zwitterionic active agent (or a salt of an active agent) may be generated with a guest salt, which includes a positive ion and a negative ion of its own. Where the active agent is provided in a salt, it may be positively or negatively charged and have a negative or positive counterion.

Physical properties of active agents, or their salts, may be modified by forming a cocrystal. Such properties include melting point, density, hygroscopicity, crystal morphology, loading volume, compressibility, and shelf life. Furthermore, other properties such as bioavailability, toxicity, taste, physical stability, chemical stability, production costs, and manufacturing method may be modified by using a cocrystal rather than the active agent alone, or as a salt.

An active agent can be screened for possible cocrystals where polymorphic forms, hydrates, or solvates are especially problematic. For example, a neutral compound that can only be isolated as amorphous material could be cocrystallized. Forming a cocrystal may up-grade the performance of a drug formulation of an active pharmaceutical ingredient by, for example, changing physical properties identified earlier.

A cocrystal can be used to isolate or purify a compound during manufacturing. If it is desirable to identify all of the solid state phases of an active pharmaceutical ingredient, then cocrystallization may be particularly desirable.

One method of preparing cocrystals involves combining melts of active agents and guests using the Kofler contact method. In a typical Kofler experiment, an active agent is heated to its melting point and then combined, in the melt state with a guest, which is also in the form of a melt. For example, the two melts are placed under a cover slip which then causes the two melts to combine and interact with one another at the interface region of where the two melts contact each other. Sometimes paraffin oil or silicon oil, which are oils wherein the active agents are insoluble, are used to help mobilize either the active agent of the guest. In these methods, it is not possible to prepare cocrystals of compounds which decompose prior to melting. In other circumstances, it is inconvenient or difficult to work with melts at high temperatures. In some instances and on some equipment, high temperatures such as those greater than about 200° C. may be inconvenient to use. Therefore, it would be advantageous to have a method wherein one could prepare cocrystals of active agents and guests which would not require heating to temperatures that either caused the active agent to decompose, that were above about 200° C., or both.

The present disclosure describes methods for screening cocrystals of active agents and guests comprising the steps of contacting an active agent with a suitable liquid to form an active-agent solution; contacting the active-agent solution with a guest solution to form an interface region mixture of the solutions; and solidifying the solution mixture to form a solid; and analyzing the solid to detect the presence of cocrystals. The present disclosure further describes methods of preparing cocrystals of active agents and guests comprising the steps of contacting the active agent with a suitable liquid to form an active-agent solution; contacting the active-agent solution with a guest solution to form a mixture of solutions in an interface region; and solidifying the solution mixture in the interface region to form a cocrystal.

The present disclosure describes methods for screening cocrystals of active agents and guests using suitable liquids. By screening, what is meant is determining whether an active agent and a guest form a cocrystal under the methods described herein. In one embodiment of the disclosure, an active agent is contacted with a suitable liquid to form a composition. The active-agent/suitable liquid composition is then heated until dissolution occurs.

The solution of the active agent and the suitable liquid is combined either with a solution containing the guest alone, which would be in the form of a melt, or a solution containing the guest and the same or a different suitable liquid than that in the active-agent solution. The solutions are combined by allowing boundaries of the two solutions to come in contact with one another at the interface region between the two solutions. Mixing occurs in the interface region but not outside of it. Thus, on the active agent side of the interface, there is substantially no guest beyond the interface and, likewise, on the guest side of the interface, there is substantially no active agent beyond the interface. Where the solutions mix in the interface region, there is a gradient of concentrations ranging from pure active agent in solution to pure guest in solution with a range of concentrations in between.

### BRIEF DESCRIPTION OF DRAWINGS

FIG. 1 is a schematic representation of one embodiment of the invention showing an active agent solution in contact with a guest solution in an interface region.

FIG. 2 is a series of micrographs showing cocrystal screening of glutaric acid and compound 1 of Example 1.

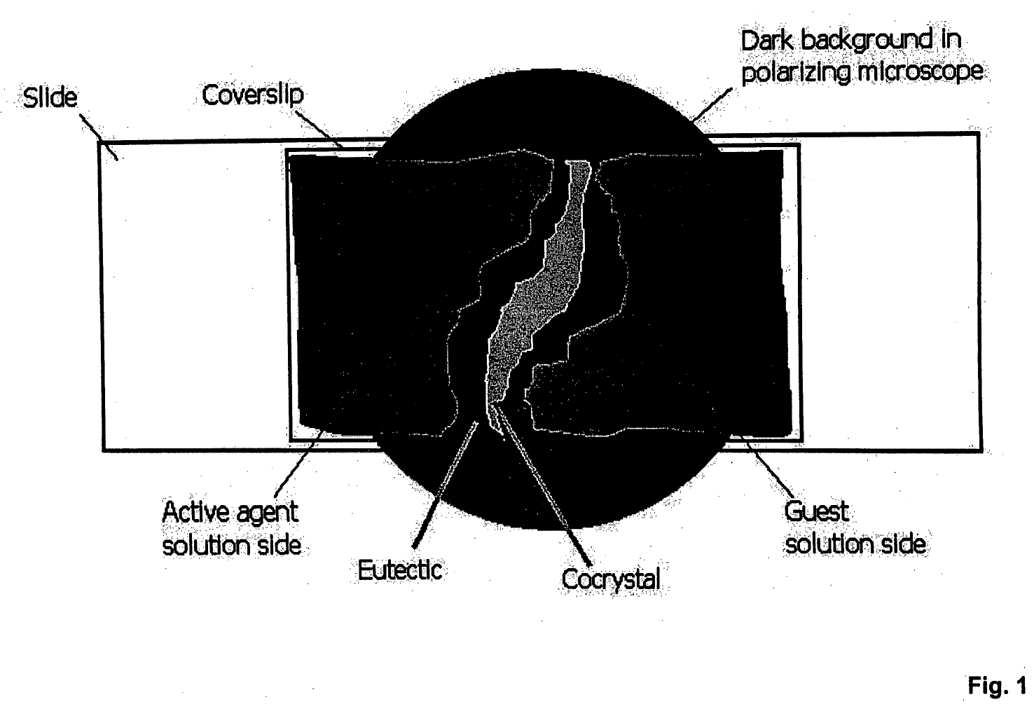

FIG. 1 illustrates an embodiment of the disclosure. In that figure, the active agent solution side has been combined with the guest solution side in the interface region. Both solutions were deposited on a slide and coverslip was placed on the slide to allow for mixing in the interface region. The figure illustrates the formation of a cocrystal which may have occurred, for instance, by cooling. In a typical experiment, the cooling procedure also solidifies the active agent solution side and the guest solution side such that much of what was previously in solution has solidified. By heat cycling the slide, it can be determined whether the solid in the center is indeed a cocrystal. If the solid is compound A, then heating the slide will show a liquid region in the interface region. Likewise, if the solid is compound B, then heating the slide will also result in a liquid in the interface region. If, however, the solid is a cocrystal of the active agent and the guest, then it will have melting properties that differ from either the active agent alone or the guest alone. Thus, heat cycling a cocrystal will yield at some points in the heat cycling a liquid on one side of the solid and at other points, a liquid on the other side of the solid.

Once the two solutions are combined into a mixture, a solidification is allowed to occur in the interface region. In one embodiment of the disclosure, solidification in the interface region occurs by cooling the interface region until a solid forms. The solid typically contains a cocrystal of the active agent and guest, the active agent alone, the guest alone, or a combination thereof. The presence of a cocrystal in the solid may be confirmed by observing eutectic formation in the interface region. Generally, a eutectic is present when the composition of a mixture of two molecular species has a minimum melting point that is lower than the melting points of the two individual molecular species.

One can determine whether eutectics occur by heat cycling the solid in the interface region. In the interface region, the mixture of the active agent and the guest causes a melting point depression effect. When the temperature is raised, the solids in the interface region melt first due to the depressed melting point. If no cocrystal has formed, then a single clear solution will be observed in the interface region. This liquid is evidence of a eutectic. If, on the other hand, a cocrystal has formed, then two separate portions of the interface regions containing eutectics will be observed, possibly at different temperatures and, therefore, at different times during a heat cycling experiment. One eutectic-containing interface region will form between the cocrystal and the active agent side and another will form in between the cocrystal and the guest side. One way to observe cocrystal presence is to view the interface region through an optical microscope equipped with polarizing filters. In such a microscope, the cocrystal will appear bright and the eutectic regions, which will only contain liquid, will appear dark.

To further analyze the cocrystal, one may use any suitable analytical technique for analyzing crystalline solids such as x-ray powder diffraction, single-crystal x-ray diffraction, Raman spectroscopy including Raman microscopy, solid-state NMR spectroscopy, and IR spectroscopy. Other analytical methods such as melting point determination, thermal gravimetric analysis, DSC, elemental analysis, and others may also provide useful information about the cocrystal. Once the cocrystal forms, a seed of the cocrystal may be used to assist in the nucleation of the cocrystal in other solidification experiments.

A suitable liquid of the disclosure is one which when combined with an active agent and heated lowers the melting point of the active agent, prevents the active agent from decomposing when heated to a temperature which, in the absence of the suitable liquid the active agent would at least partially decompose, or both.

Many active agents have relatively high melting points. For example, agents with a melting temperature of greater than about 200° C. are difficult to work with or melt on many experimental instruments. In addition, many active agents are prone to decompose when heated prior to reaching their melting point. Further, the greater the difference between the melting point values of active agents and guests, the greater the difficulty in observing eutectic formation during a Kofler contact method experiment.

A suitable liquid of the disclosure, when combined with an active agent forms a solution at a lower temperature than that of the melting point of the active agent. By varying the amount of suitable liquid used, one can also vary the temperature at which dissolution of the active agent occurs.

When selecting suitable liquids for the methods of the disclosure, it has been observed that different suitable liquids may have different properties with respect to any given active agent. One of the factors involved in selecting a suitable liquid is the temperature at which dissolution occurs. For example, it is generally inconvenient to perform the cocrystal screening experiments of the invention at temperature above about 200° C. due, for instance, to the evolution of potentially toxic fumes at such elevated temperatures. Thus, it is often valuable to have a suitable liquid/active agent combination wherein dissolution occurs at a temperature less than about 200° C. Other factors when selecting a suitable liquid for a particular active agent is the ability of the active agent to nucleate in the suitable liquid, the growth rate of crystals of the active agent in the suitable liquid, and the quality of crystals that may grow from the suitable liquid.

The nucleation and crystallization behavior of the active agent, the guest, or both, may be affected by which suitable liquid is employed. A factor that may affect nucleation and crystallization includes the ability of the suitable liquid to accept or donate hydrogen bonds. Thus, a number of suitable liquids may be tested in any given screen for cocrystals in order to determine which promotes the preferred crystallization behavior of the active agent or guest.

Suitable liquids of the disclosure are typically organic compounds that are liquids or oils at room temperature. In one embodiment, suitable liquids have low toxicity in order to minimize the biological effects of volatile fumes that may be created during the melting process.

Examples of suitable liquids of the disclosure include but are not limited to benzyl alcohol
phenethyl alcohol
ethyl butyrate ethyl acetoacetate
methyl benzoate
ethyl benzoate
anisole
cyclopentanone
ethyl isovalerate
cymene
p-anisaldehyde
1,1-diethoxyethane
methyl propionate
2′-hydroxyacetophenone
ethyl cinnamate
ethyl phenylacetate
ethyl salicylate
gamma-valerolactone
phenylethanal
2-methoxy-4-methylphenol
3-phenylpropionaldehyde
1-phenylethyl propionate
ethyl 4-methoxybenzoate
salicylylaldehyde
2,2′-oxybisethanol
methyl salicylate
p-anisaldehyde
2′-hydroxyacetophenone
p-methylacetophenone
ethylene glycol
dimethylsulfoxide
dimethyl formamide
octyl alcohol
nitro-benzene
benzonitrile

The active agent is the molecule whose activity is desirable. One or more active agents may be employed in a cocrystal, according to the methods of the disclosure.

Active agents may include APIs. Examples of APIs (or salts thereof) may be found, for instance, in the FDA Orange Book. Other examples of active agents include nutraceuticals, agricultural chemicals, pigments, dyes, explosives, polymer additives, lubricant additives, photographic chemicals, or structural and electronic materials.

The active agent may be provided as a salt. One or more salts may be employed in a cocrystal, according to the methods of the disclosure. The salt may be prepared from the active agent or obtained from a commercial source. In the pharmaceutical industry, for instance, hydrochloride salts of active pharmaceutical ingredients, especially of amine APIs, are commonly used. The present cocrystals may comprise salts other than chloride salts. Examples of salts include, but are not limited to, those formed from the following acids:
sulfuric acid
phosphoric acid
hydrobromic acid
nitric acid
pyrophosphoric acid
methanesulfonic acid
thiocyanic acid
naphthalene-2-sulfonic acid
1,5-naphthalenedisulfonic acid
cyclamic acid
p-toluenesulfonic acid
maleic acid
L-aspartic acid
2-hydroxy-ethanesulfonic acid
glycerophosphoric acid
ethanesulfonic acid
hydroiodic acid

In other aspects of the disclosure, the active agent is an anion of a salt. Cations (including cations as well as compounds that can form cations) for preparing active agents as salts include, but are not limited to, aluminum, ammonium, benzathine, calcium, diethanolamine, diethylamine, dimeglumine, disodium, lithium, lysine, magnesium, meglumine, potassium, sodium, and zinc. Among the preferred anions are acetate, L-aspartate, besylate, bicarbonate, carbonate, D-camsylate, L-camsylate, citrate, edisylate, fumarate, gluconate, hydrobromide/bromide, hydrochloride/chloride, D-lactate, L-lactate, DL-lactate, D,L-malate, L-malate, mesylate, pamoate, phosphate, succinate, sulfate, D-tartrate, L-tartrate, D,L-tartrate, meso-tartrate, benzoate, gluceptate, D-glucuronate, hybenzate, isethionate, malonate, methylsufate, 2-napsylate, nicotinate, nitrate, orotate, stearate, tosylate, acefyllinate, aceturate, aminosalicylate, ascorbate, ascorbate, borate, butyrate, camphorate, camphocarbonate, decanoate, hexanoate, cholate, cypionate, dichloroacetate, edentate, ethyl sulfate, furate, fusidate, galactarate (mucate), galacturonate, gallate, gentisate, glutamate, glutamate, glutarate, glycerophosphate, heptanoate (enanthate), hydroxybenzoate, hippurate, phenylpropionate, iodide, xinafoate, lactobionate, laurate, maleate, mandelate, methanesufonate, myristate, napadisilate, oleate, oxalate, palmitate, picrate, pivalate, propionate, pyrophosphate, salicylate, salicylsulfate, sulfosalicylate, sulfosalicylate, tannate, terephthalate, thiosalicylate, tribrophenate, valerate, valproate, adipate, 4-acetamidobenzoate, camsylate, octanoate, estolate, esylate, glycolate, thiocyanate, and undecylenate.

When a metal cation is employed as a counterion of the active agent, the interaction between the guest of a cocrystal and the cation is not a hydrogen bond but rather is an intermolecular interaction between an electron rich group such as a carbonyl and the metal cation. This interaction is often not as strong as a hydrogen bond, but is still a favorable interaction and thus can contribute to the stabilization of the cocrystal.

When the active agent is a HCl salt, one can cocrystallize the HCl salt with a neutral guest molecule. By doing this one can create solid state phases with specific properties. For instance one can make a solid comprising an active pharmaceutical ingredient having greater or lesser intrinsic solubility and/or a faster or slower dissolution rate, depending on the guest compound that is chosen.

By “guest” what is meant is the component of the cocrystal that is not the active agent of the disclosure. The guest is present in order to form the cocrystal with the active agent. It is contemplated that one or more guests may be employed in a cocrystal, according to any of the techniques of the disclosure. Accordingly, the guest is not required to have an activity of its own, although it may have some activity. In some situations, the guest may have the same activity as or an activity complementary to that of the active agent. The guest may be another active agent. For example, some guests may facilitate the therapeutic effect of an active pharmaceutical ingredient. For pharmaceutical formulations, the guest may be any pharmaceutically acceptable molecule(s) that forms a cocrystal with the API or its salt. The Registry of Toxic Effects of Chemical Substances (RTECS) database is a useful source for toxicology information, and the GRAS list contains about 2500 relevant compounds. Both sources may be used to help identify guests.

The guest may be neutral (such as benzoic acid and succinic acid in the examples below) or ionic (such as sodium benzoate or sodium succinate). Neutral guests are nonionic guests. Ionic guests are compounds or complexes having ionic bonds. General classes of guests include but are not limited to organic bases, organic salts, alcohols, aldehydes, amino acids, sugars, ionic inorganics, aliphatic esters, aliphatic ketones, organic acids, aromatic esters, and aromatic ketones. The guest may be an acid that forms hydrogen bonds with the chloride (or other anion). For example, suitable guests which are acids include (but not are not limited to):
ascorbic acid
glucoheptonic acid
sebacic acid
alginic acid
cyclamic acid
ethane-1,2-disulfonic acid
2-hydroxyethanesulfonic acid
2-oxo-glutaric acid
naphthalene-1,5-disulfonic acid
nicotinic acid
pyroglutamic acid
4-acetamidobenzoic acid

Table 1 sets forth a group of guests of the disclosure. It is contemplated that the guests set forth in the Table may be arranged in subgroups based upon molecular structure and/or physiological effect. Furthermore, the foregoing list is intended to provide a written description of any sublist that omits one or more guests.

TABLE 1

| | |
|---|---|
| 10-camphorsulfonic acid | oleic acid |
| 10-undecylenic acid | o-methylbenzoic acid |
| 1-hydroxy-2-napthoic acid | orotic acid |
| 2,4-dihydroxybenzoic acid | orthoboric acid |
| 2,5-dihydroxybenzoic acid | o-toluic acid |
| 2-aminopropionic acid | p-acetamidobenzoic acid |
| 2-ethylbutyrinc acid | palmitic acid |
| 2-furancarboxylic acid | pamoic acid |
| 2-mercapotobenzoic acid | phenoxyacetic acid |
| 3-methylbutanoic acid | phenylacetic acid |
| 3phenylpropionic acid | phenylalanine |
| 4-aminobenzoic acid | picric acid |
| 4-aminosalicylic acid | pivalic acid |
| 4-hydroxybenzoic acid | proline |
| adipic acid | p-toluenesulfonic acid |
| alginic acid | pyroglutamic acid |
| anisic acid | pyruvic add |
| arginine | salicyclic acid |
| ascorbic acid | sebacic acid |
| asparagine | serine |
| aspartic acid | sorbic acid |
| aspirin | stearic acid |
| benzenesulfonic acid | succinic acid |
| benzoic acid | sulfosalicylic acrid |
| 4-acetamidobenzoic acid | tartaric acid |
| beta-alanine | terephthalic acid |
| camphoric acid | thiocyanic acid |
| camphorsulfonic acid | threonine |
| carbonic acid | tiglic acid |
| cholic acid | tryptophan |
| cinnamic acid | tyrosine |
| citric acid | valeric acid |
| cyclamic acid | valine |
| cyclohexanecarboxylic acid | |
| cyclohexylacetic acid | |
| cysteine | |
| diphenylacetic acid | |
| dodecylsulfonic acid | |
| ethane-1,2-disulfonic acid | |
| ethanesulfonic acid | |
| ethanesulfonic acid, 2-hydroxy | |
| ethylenediaminetetraacetic acid | |
| ethylsulfuric acid | |
| fumaric acid | |
| galactaric acid | |
| gallic acid | |
| gentisic acid | |
| glucoheptonic acid | |
| gluconic acid | |
| glutamic Acid | |
| glutamine | |
| glutaric acid | |
| glutaric acid, 2-oxo- | |
| glycine | |
| glycolic acid | |
| hippuric acid | |
| histidine | |
| hydroxypropline | |
| isoleucine | |
| lactobionic acid | |
| lauric acid | |
| leucine | |
| levulinic acid | |
| lysine | |
| maleic acid | |
| malic acid | |
| malonic acid | |
| mandelic acid | |
| m-methoxybenzoic acid | |
| naphthalene-1,5,disulfonic acid | |
| naphthalene-2-sulfonic acid | |
| n-decanoic acid | |
| niacin | |
| nicotinic acid | |
| n-tetradecanoic acid | |

Table 2 sets forth another group of guests of the disclosure. It is contemplated that the guests set forth in the Table may be arranged in subgroups based upon molecular structure and/or physiological effect. Furthermore, the foregoing list is intended to provide a written description of any sublist that omits one or more guests.

TABLE 2

| Name | CAS # |
|---|---|
| Potassium bicarbonate | 298-14-6 |
| Potassium carbonate | 584-08-7 |
| Potassium chloride | 7447-40-7 |
| Potassium hydroxide | 1310-58-3 |
| Potassium metabisulfite | 16731-55-8 |
| Potassium nitrate | 7757-79-1 |
| Potassium nitrate | 7758-09-0 |
| Potassium permanganate | 7722-64-7 |
| Potassium persulfate | 7727-21-1 |
| Potassium phosphate, dibasic | 2139900 |
| Potassium Phosphate | 7778-77-0 |
| Monobasic | 7778-53-2 |
| potassium phosphate, tribasic, | |
| n-hydrate | |
| Potassium sulfate | 7778-80-5 |
| Sodium bicarbonate | 144-55-8 |
| Sodium bisulfite | 7631-90-5 |
| Sodium borohydride | 16940-66-2 |
| Sodium carbonate | 497-19-8 |
| Sodium Carbonate Monohydrate | 1486118 |
| Sodium chloride | 7647-14-5 |
| Sodium dithionite | 7775-14-6 |
| Sodium fluoride | 7681-49-4 |
| Sodium hexamataphosphate | 10124-56-8 |
| Sodium hydroxide | 1310-73-2 |
| Sodium hypochlorite | 7681-52-9 |
| Sodium Metabisulfite | 7681-57-4 |
| Disodium metasilicate | 6834-92-0 |
| sodium monophosphate | 7681-53-0 |
| Sodium nitrate | 7631-99-4 |
| Sodium nitrite | 7632-00-0 |
| sodium hydrogen phosphate | 7558-79-4 |
| Sodium Phosphate Monobasic | 7558-80-7 |
| Sodium Pyrophosphate | 7722-88-5 |
| Sodium silicate | 1344-09-8 |
| Sodium Sulfate Decahydrate | 7727-73-3 |
| Sodium sulfite | 7757-83-7 |
| Sodium Thiosulfate | 10102-17-7 |
| Pentahydrate | |
| Calcium acetate | 5743-26-0 |
| Calcium Carbonate | 471-34-1 |
| Calcium Chloride Dihydrate | 10035-04-8 |
| Calcium gluconate | 299-28-5 |
| calcium hydroxide | 1305-62-0 |
| Calcium oxide | 1305-78-8 |
| Calcium phosphate, dibasic | 7757-93-9 |
| Calcium Phosphate Monobasic | 7758-23-8 |
| Calcium sulfate | 7778-18-9 |
| Magnesium hydroxide | 1309-42-8 |
| Magnesium Sulfate | 10034-99-8 |
| Heptahydrate | |
| Aluminum | 7429-90-5 |
| Aluminum ammonium sulfate | 7784-26-1 |
| Aluminum chloride | 7446-70-0 |
| Aluminum hydroxide | 21645-51-2 |
| Aluminum potassium sulfate, | 7784-24-9 |
| dodecahydrate | |
| Orthoboric acid | 10043-35-3 |
| formaldehyde | 50-00-0 |
| DL-Isoleucine | 443-79-8 |
| (2S,7S)-(−)Cystine | 56-89-3 |
| DL-Alanine | 302-72-7 |
| beta-Alanine | 107-95-9 |
| (S)-(+)-Arginine | 74-79-3 |
| (S)-(−)-Cysteine | 52-90-4 |
| DL-Glutamic acid | 617-65-2 |
| Glycine | 56-40-6 |
| (S)-(−)-Histine | 71-00-1 |
| (S)-(+)-Lysine | 56-87-1 |
| DL-Methionine | 59-51-8 |
| DL-Phenlalanine | 150-30-1 |
| (S)-(−)Phenylalanine | 63-91-2 |
| D-(+)-Proline | 344-25-2 |
| (S)-(−)-Tryptophan | 73-22-3 |
| (S)-(−)-Tyrosine | 60-18-4 |
| Carvone | 99-49-0 |
| Citral | 5392-40-5 |
| Ethyl butyrate | 105-54-4 |
| Isobutyl propionate | 540-42-1 |
| Methyl butyrate | 623-42-7 |
| n-Propyl acetate | 109-60-4 |
| Isobutyl formate | 542-55-2 |
| Benzyl acetate | 140-11-4 |
| 6-Methyl-5-hepten-2-one | 110-93-0 |
| Butyl acetate | 123-86-4 |
| Ethyl acetoacetate | 141-97-9 |
| Isopentyl Acetate | 123-92-2 |
| Cinnamaldehyde | 104-55-2 |
| Methyl benzoate | 93-58-3 |
| Butyl sulfide | 544-40-1 |
| Ethyl benzoate | 93-89-0 |
| 2,4-Hexadienoic acid, | 24634-61-5 |
| potassium salt, (E,E)- | |
| Potassium bitartrate | 868-14-4 |
| Lauric acid | 143-07-7 |
| Benzyl benzoate | 120-51-4 |
| Picric acid | 88-89-1 |
| Benzoyl peroxide | 94-36-0 |
| Palmitic acid | 57-10-3 |
| Dibutyl phthalate | 84-74-2 |
| Stearic acid | 57-11-4 |
| Succinic anhydride | 108-30-5 |
| Diethylenetriamine | 111-40-0 |
| Diethanolamine | 111-42-2 |
| Benzaldehyde | 100-52-7 |
| Phenethylamine | 64-04-0 |
| Salicylylaldehyde | 90-02-8 |
| Sodium benzoate | 532-32-1 |
| Cinnamic acid | 621-82-9 |
| Triethanolamine | 102-71-6 |
| L-(+)-Tartaric Acid | 87-69-4 |
| Eugenol | 97-53-0 |
| D-mannitol | 69-65-8 |
| Butyl paraben | 94-26-8 |
| Benzoin | 119-53-9 |
| Diethyl phthalate | 84-66-2 |
| Oleic acid | 112-80-1 |
| Sodium lactate | 72-17-3 |
| Indole | 120-72-9 |
| etbyl lactate | 97-64-3 |
| quinoline | 91-22-5 |
| Thymol | 89-83-8 |
| Methyl anthranilate | 134-20-3 |
| Methyl salicylate | 119-36-8 |
| Diethyl malonate | 105-53-3 |
| Citric acid | 77-92-9 |
| Sodium dodecyl sulfate | 151-21-3 |
| Morpholine | 110-91-8 |
| Furfural | 98-01-1 |
| Niacin | 59-67-6 |
| Choline chloride | 67-48-1 |
| L-Menthol | 2216-51-5 |
| Meso-inositol | 87-89-8 |
| ethylenediaminetetraacetic | 60-00-4 |
| acid | |
| EDTA, calcium derivative, | 62-33-9 |
| disodium salt | |
| Calcium pantothemate | 137-08-6 |
| Riboflavin | 83-88-5 |
| Zinc carbonate | 3486-35-9 |
| Amyl alcohol | 71-41-0 |
| Mineral oil | 8012-95-1 |
| Triton(R) X-100 | 9002-93-1 |
| Acetaldehyde | 75-07-0 |
| Acetic Acid | 64-19-7 |
| Acetone | 67-64-1 |
| Acetophenone | 98-86-2 |
| 4-Aminobenzoic acid | 150-13-0 |
| Anisole | 100-66-3 |
| Vitamin C | 50-81-7 |
| Benzoic Acid | 65-85-0 |
| Biphenyl | 92-52-4 |
| 2-Methyl-1 propanol | 78-83-1 |
| n-Butanol | 71-36-3 |
| n-Butylamine | 109-73-9 |
| ethyl acetate | 141-78-6 |
| Caffeine | 58-08-2 |
| Chloroacetic Acid | 79-11-8 |
| Dichloroacetic Acid | 79-43-6 |
| Diethylamine | 109-89-7 |
| Ethanol Amine | 141-43-5 |
| n-Butyric Acid | 107-92-6 |
| Ethylenediamine | 107-15-3 |
| Formic acid | 64-18-6 |
| n-Hexanol | 111-27-3 |
| Methanol | 67-56-1 |
| Methyl Acetate | 79-20-9 |
| Methyl 4-hydroxybenzoate | 99-76-3 |
| m-Cresol | 108-39-4 |
| p-Cresol | 106-44-5 |
| Phenol | 108-95-2 |
| n-Propanol | 71-23-8 |
| Propionic Acid | 79-09-4 |
| Salicylic acid | 69-72-7 |
| Sucrose | 57-50-1 |
| Vanillin | 121-33-5 |
| Vitamin E | 59-02-9 |
| Potassium citrate, monohydrate | 1534146 |
| p-toluenesulfonic acid | 6192-52-5 |
| monohydrate | |
| D-(+)-Maltose | 69-79-4 |
| Tetrasodium | 64-02-8 |
| ethylenediaminetetraacetate | |
| Saccharin sodium | 128-44-9 |
| Sodium Acetate Trihydrate | 6131-90-4 |
| Quinine sulfate, dihydrate | 6119-70-6 |
| Sulfosalicylic acid, dihydrate | 5965-83-3 |
| L-(+)-Arginine | 1119-34-2 |
| monohydrochloride | |
| Procaine hydrochloride | 51-05-8 |
| Pyridoxine Hydrochloride | 58-56-0 |
| Thiamine hydrochloride | 67-03-8 |
| Propionaldehyde | 123-38-6 |
| Urea | 57-13-6 |
| 2-Propanol | 67-63-0 |
| Pyrrole | 109-97-7 |
| Sodium formate | 141-53-7 |
| Pyrrolidine | 123-75-1 |
| Methyl ethyl ketone | 78-93-3 |
| Ethyl formate | 109-94-4 |
| Propylene glycol | 57-55-6 |
| Thiourea | 62-56-6 |
| Ammonium acetate | 631-61-8 |
| Benzene | 71-43-2 |
| Sodium acetate | 127-09-3 |
| Cyclopentanone | 120-92-3 |
| Cyclohexane | 110-82-7 |
| piperidine | 110-89-4 |
| 2-Pentanone | 107-87-9 |
| hexane | 110-54-3 |
| Isoamyl Alcohol | 123-51-3 |
| Lactic acid | 50-21-5 |
| 2-Ethoxyethanol | 110-80-5 |
| Propionic acid, sodium salt | 137-40-6 |
| Potassium acetate | 127-08-2 |
| cyclohexyl amine | 108-91-8 |
| methyl methacrylate | 80-62-6 |
| methyl isobutyl ketone | 108-10-1 |
| Acetic anhydride | 108-24-7 |
| Isopropyl Acetate | 108-21-4 |
| 2,2′-Oxybisethanol | 111-46-6 |
| Benzyl alcohol | 100-51-6 |
| Resorcinol | 108-46-3 |
| 2-Butoxy ethanol | 111-76-2 |
| Cumene | 98-82-8 |
| 2-Amino-2-(hydroxymethyl)-1,3- | 77-86-1 |
| propanediol | |
| Phenethyl alcohol | 60-12-8 |
| 2-Ethyl-1-hexanol | 104-76-7 |
| 2-Octanol | 123-96-6 |
| 2-(2-Ethoxyethoxy) ethanol | 111-90-0 |
| 2,6-(Dimethyl-4-heptanone | 108-83-8 |
| Benzophenone | 119-61-9 |
| D-(−)-Fructose | 57-48-7 |
| D-Glucose | 50-99-7 |
| D-Ribose | 50-69-1 |
| D-(+)-Xylose | 58-86-6 |
| Pectin sugar | 5328-37-0 |
| D-(+)-Lactose | 63-42-3 |
| Camphene | 79-92-5 |
| Isoquinoline | 119-65-3 |
| 2,4-Dimethylphenol | 105-67-9 |
| 2,5-Dimethylphenol | 95-87-4 |
| 2,6-Dimethylphenol | 576-26-1 |
| Methanesulfonic Acid | 75-75-2 |
| o-Methoxybenzoic Acid | 579-75-9 |
| Saccharin | 81-07-2 |
| Thiazole | 288-47-1 |
| Trifluoromethanesulfonic Acid | 1493-13-6 |
| Trimethylamine | 75-50-3 |
| Coumarin | 91-64-5 |
| Dimethylamine | 124-40-3 |
| Ethyl Alcohol | 64-17-5 |
| Butyl benzyl phthalate | 85-68-7 |
| 2,6-dimethylpyrazine | 108-50-9 |
| taurocholic acid | 81-24-3 |
| geraniol | 106-24-1 |
| linalool | 78-70-6 |
| ethyl isovalerate | 108-64-5 |
| ethyl 2-methylbutyrate | 7452-79-1 |
| 1-octen-3-ol | 3391-86-4 |
| ethyl 2-trans-4-cis- | 3025-30-7 |
| decadienoate | |
| Dihydromyrcenol | 18479-58-8 |
| citronellal | 106-23-0 |
| linalyl acetate | 115-95-7 |
| 8-mercapto-p-menthan-3-one | 38462-22-5 |
| Ammonium citrate | 3012-65-5 |
| Ammonium bicarbonate | 1066-33-7 |
| Ammonium chloride | 12125-02-9 |
| Ammonium hydroxide | 1336-21-6 |
| Ammonium persulfate | 7727-54-0 |
| Ammonium phosphate, dibasic | 7783-28-0 |
| Ammonium Phosphate | 7722-76-1 |
| Monobasic | |
| Ammonium sulfate | 7783-20-2 |
| Ammonium sulfide | 12135-76-1 |
| Hydrazine | 302-01-2 |
| Nitric acid | 7697-37-2 |
| phosphoric acid | 7664-38-2 |
| Phosphorus oxychloride | 10025-87-3 |
| Hydriodic acid | 10034-85-2 |
| Hydrobromic acid | 10035-10-6 |
| Huydrochloric acid | 7647-01-0 |
| hydrogen peroxide | 7722-84-1 |
| Periodic Acid | 10450-60-9 |
| Sulfamic acid | 5329-14-6 |
| Sulfuric acid | 7664-93-9 |
| Sulfurous acid | 7782-99-2 |
| Dexpanthenol | 81-13-0 |
| 4-oxoisophorone | 1125-21-9 |
| Copper(II) sulfate | 7758-98-7 |
| ferric chloride | 7705-08-0 |
| Ferric oxide | 1309-37-1 |
| ferric sulfate | 10028-22-5 |
| Iron (II) Sulfate Heptahydrate | 7782-63-0 |
| Iron | 7439-89-6 |
| Manganese (II) Sulfate | 10034-96-5 |
| Monohydrate | |
| Nickel | 7440-02-0 |
| Titanium dioxide | 13463-67-7 |
| Zinc chloride | 7646-85-7 |
| Zinc oxide | 1314-13-2 |
| 1,1′-Azobisformamide | 123-77-3 |
| 1,3-Butanediol | 107-88-0 |
| 1-Methylnaphtalene | 90-12-0 |
| 2,6-Di-tert-Butyl-p-Cresol | 128-37-0 |
| 2,6-Dimethylpyridine | 108-48-5 |
| Disodium | 138-93-2 |
| cyanodithiomidocarbonate | |
| 3-Methyl-2-Cyclopentene-2-ol- | 80-71-7 |
| one | |
| 6-Methylcoumarin | 92-48-8 |
| acetoin | 513-86-0 |
| alpha-Phellandrene | 99-83-2 |
| alpha-Terpinene | 99-86-5 |
| Benzenesulfonic Acid | 98-11-3 |
| Benzothiazole | 95-16-9 |
| borates, tetrasodium salts | 1330-43-4 |
| Butyl butyrate | 109-21-7 |
| Butyl Mercaptan | 109-79-5 |
| Butyraldehyde | 123-72-8 |
| Capasaicin | 404-86-4 |
| Chloromethyl Methyl Ether | 107-30-2 |
| Cymene | 99-87-6 |
| Diallyl Disulfide | 2179-57-9 |
| Diethylaminoethanol | 100-37-8 |
| dimethyldisulfide | 624-92-0 |
| Dimethyl Succinate | 106-65-0 |
| Dimethyl Sulfate | 77-78-1 |
| Dimethyl Sulfide | 75-18-3 |
| Dipropyl Disulfide | 629-19-6 |
| Dipropyl Ketone | 123-19-3 |
| Ethyl Acrylate | 140-88-5 |
| Ethyl Butyl Ketone | 106-35-4 |
| Ethyl Propionate | 105-37-3 |
| Furfuryl Alcohol | 98-00-0 |
| gamnma-Butyrolactone | 96-48-0 |
| Glutaraldehyde | 111-30-8 |
| gylcerin | 56-81-5 |
| Glycolic Acid | 79-14-1 |
| Isobutyl Acetate | 110-19-0 |
| Isobutyl Isobutyrate | 97-85-8 |
| Isobutyraldehyde | 78-84-2 |
| Isoheptanol | 543-49-7 |
| Isophorone | 78-59-1 |
| Isopropyl Mercaptan | 75-33-2 |
| Methyl isobutenyl ketone | 141-79-7 |
| Methyl n-amyl ketone | 110-43-0 |
| methyl acrylate | 96-33-3 |
| Methyl Isobutyrate | 547-63-7 |
| Methyl Mercaptan | 74-93-1 |
| N,N-Dimethylethanolamine | 108-01-0 |
| n-Butyl Lactate | 138-22-7 |
| n-Hexyl Acetate | 142-92-7 |
| n-Valeraldehyde | 110-62-3 |
| Nitrous Oxide | 10024-97-2 |
| p-Anisaldehyde | 123-11-5 |
| 2-Methylcyclohexanone | 583-60-8 |
| Octanoic Acid | 124-07-2 |
| Oxalic Acid | 144-62-7 |
| Phenyl ether | 101-84-8 |
| Phenylmercaptan | 108-98-5 |
| Propargyl Alcohol | 107-19-7 |
| Propyl paraben | 94-13-3 |
| sec-Butyl Alcohol | 78-92-2 |
| Sodium Gluconate | 527-07-1 |
| Sodium Tripolyphosphate | 7758-29-4 |
| Tetrahydro-2-furanmethanol | 97-99-4 |
| Valeric Acid | 109-52-4 |
| 3,4-xylenol | 95-65-8 |
| 3-hexanol | 623-37-0 |
| 3-methyl-1-pentanol | 589-35-5 |
| 1,1-diethoxyethane | 105-57-7 |
| Aluminum Sulfate | 10043-01-3 |
| ammonium sulfite | 10196-04-0 |
| amyl butyrate | 540-18-1 |
| borneol | 507-70-0 |
| butyl formate | 592-84-7 |
| calcium peroxide | 1305-79-9 |
| n-Hexanoic Acid | 142-62-1 |
| cyclohexyl acetate | 622-45-7 |
| diacetyl | 431-03-8 |
| dimethyl carbonate | 616-38-6 |
| ethyl butyraldehyde | 97-96-1 |
| Ethyl crotonate | 623-70-1 |
| ethyl isobutyrate | 97-62-1 |
| ethyl nitrite | 109-95-5 |
| fumaric acid | 110-17-8 |
| hexaldehyde | 66-25-1 |
| isobutyric acid | 79-31-2 |
| methyl isovalerate | 556-24-1 |
| methyl propionate | 554-12-1 |
| methyl valeraldehyde | 123-15-9 |
| nitrosyl chloride | 2696-92-6 |
| octafluorocyclobutane | 115-25-3 |
| peroxyacetic acid | 79-21-0 |
| propyl formate | 110-74-7 |
| propyl mercaptan | 107-03-9 |
| Sodium aluminate | 1302-42-7 |
| sodium chlorite | 7758-19-2 |
| Terephthalic Acid | 100-21-0 |
| allyl isothiocyanate | 57-06-7 |
| Vitamin B1 | 59-43-8 |
| Valproic acid | 99-66-1 |
| Ethoxyquin | 91-53-2 |
| n-Amyl Ethyl Ketone | 106-68-3 |
| Nabam | 142-59-6 |
| Sodium sulfide | 1313-82-2 |
| Thiocyanic acid | 463-56-9 |
| 2-Methyl-5-(1-methylethenyl)- | 2244-16-8 |
| 2-cyclohexene-1-one | |
| 4-(2,6,6-Trimethyl-2- | 127-41-3 |
| cyclohexen-1-yl)-3-buten-2-one | |
| 4-(2,6,6-trimethyl-1- | 14901-07-6 |
| cyclohexen-1-yl)-3-buten-2-one | |
| Isoamyl propionate | 105-68-0 |
| 3-Methylbutanoic acid | 503-74-2 |
| L-Menthone | 14073-97-3 |
| 4-Ethylphenol | 123-07-9 |
| o-cresol | 95-48-7 |
| dimethyl-Carbamodithioic acid, | 128-04-1 |
| sodium salt | |
| Anethole | 104-46-1 |
| Dimethyl terephthalate | 120-61-6 |
| propyl gallate | 121-79-9 |
| L-Ascorbic Acid Sodium Salt | 134-03-2 |
| 4-Hexylresorcinol | 136-77-6 |
| Estragole | 140-67-0 |
| L-monosodium glutamate | 142-47-2 |
| Malonaldehyde, sodium salt | 24382-04-5 |
| Butylated hydroxyanisole | 25013-16-5 |
| allyl 3-methylbutyrate | 2835-39-4 |
| DL-monosodium glutamate | 32221-81-1 |
| 3-Acetyl-6-methyl-2,4- | 520-45-6 |
| pyrandione | |
| L-Glutamic Acid | 56-86-0 |
| DL-alpha-tocopheryl acetate | 58-95-7 |
| D-limonene | 5989-27-5 |
| Calcium Acetate | 62-54-4 |
| Erythorbic Acid Monosodium | 6381-77-7 |
| Salt | |
| Ethyl methylphenylglycidate | 77-83-8 |
| 2,4,6-Trinitro-1,3-dimethyl-5- | 81-15-2 |
| tert-butylbenzene | |
| Dimethoxane | 828-00-2 |
| 3,5-Di-tert--butyl-4- | 88-26-6 |
| hydroxybenzyl alcohol | |
| 6-Methylquinoline | 91-62-3 |
| alpha-Methylbenzyl alcohol | 98-85-1 |
| Nicotinamide | 98-92-0 |
| 3,4-Dihydrocoumarin | 119-84-6 |
| Geranyl Acetate | 105-87-3 |
| Sodium (2-Ethylhexyl)Alcohol | 126-92-1 |
| Sulfate | |
| Cyclohexanol, 5-methyl-2-(1- | 89-78-1 |
| methylethyl)-, | |
| (1alpha,2beta,5alpha)- | |
| (+)-Camphor | 464-49-3 |
| (1S)-(−)-alpha-Pinene | 7785-26-4 |
| 1,3-Dihydroxy-5-methylbenzente | 504-15-4 |
| 1,5-Naphthalenedisulfonic Acid | 1655-29-4 |
| Disodium Salt | |
| 1-Hydroxy-2-naphthoic Acid | 86-48-6 |
| 1-Penten-3-ol | 616-25-1 |
| 1-Phenyl-1-propanol | 93-54-9 |
| 10-Undecylenic Acid | 112-38-9 |
| 2′-Hydroxyacetophenone | 118-93-4 |
| 2,4-Dihydroxybenzoic Acid | 89-86-1 |
| 2-Acetylfuran | 1192-62-7 |
| 2-Furancarboxylic Acid | 88-14-2 |
| 2-Isopropylphenol | 88-69-7 |
| 2-Ketoglutaric Acid | 328-50-7 |
| 2-Ketovaline | 759-05-7 |
| 2-n-Propylphenol | 644-35-9 |
| 2-Naphthalenethiol | 91-60-1 |
| 2-Phenyl-1-propanol | 1123-85-9 |
| 3,3′-Thiodipropionic Acid | 111-17-1 |
| 3,5,5-Trimethylhexanal | 5435-64-3 |
| 3-Phenyl-1-propanol | 122-97-4 |
| 3-Phenylpropionic Acid | 501-52-0 |
| 4-Aminosalicylic Acid | 65-49-6 |
| 4-Ethoxyphenol | 622-62-8 |
| 4-Hydroxybenzoic Acid | 99-96-7 |
| 4-Phenyl-2-butanol | 2344-70-9 |
| 4-tert-Octylphenol | 140-66-9 |
| Allyl Cinnamate | 1866-31-5 |
| Ally Mercaptan | 870-23-5 |
| alpha-L-Rhamnose | 3615-41-6 |
| Alpha-Terpineol | 98-55-5 |
| Anisic Acid | 100-09-4 |
| Benzalacetone | 122-57-6 |
| Benzaldehyde Dimethylacetal | 1125-88-8 |
| Benzyl Ether | 103-50-4 |
| Benzyl Formate | 104-57-4 |
| Benzyl Mercaptan | 100-53-8 |
| Benzyl Salicylate | 118-58-1 |
| Calcium Citrate | 813-94-5 |
| Calcium Glycerophosphate | 27214-00-2 |
| Calcium Hypophosphite | 7789-79-9 |
| Calcium lodate | 7789-80-2 |
| Propanoic acid, 2-hydroxy-, | 814-80-2 |
| calcium salt (2:1) | |
| Calcium Phosphate Tribasic | 7758-87-4 |
| Calcium Propionate | 4075-81-4 |
| Calcium Pyrophosphate | 7790-76-3 |
| Cholic Acid | 81-25-4 |
| Choline | 123-41-1 |
| Choline Bitartrate | 87-67-2 |
| trana-Cinnamic Aldehyde | 14371-10-9 |
| Cinnamyl Alcohol | 104-54-1 |
| Citronellol | 106-22-9 |
| Copper(I)Iodide | 7681-65-4 |
| D-(+)-Glucono-1,5-lactone | 90-80-2 |
| D-(−)-Tartaric Acid | 147-71-7 |
| D-Isoascorbic Acid | 89-65-6 |
| D-Tyrosine | 556-02-5 |
| Sodium dehydroacetate | 4418-26-2 |
| Deoxycholic Acid | 83-44-3 |
| Dibenzyl Ketone | 102-04-5 |
| Diethyl L-(+)-Tartrate | 87-91-2 |
| Diethyl Succinate | 123-25-1 |
| Dimethylacetal | 534-15-6 |
| DL-Cystine | 923-32-0 |
| DL-Proline | 609-36-9 |
| DL-Tartaric Acid | 133-37-9 |
| DL-Tyrosine | 556-03-6 |
| DL-Valine | 516-06-3 |
| Enanthoic Acid | 111-14-8 |
| Erythorbic Acid Sodium Salt | 7378-23-6 |
| Ethyl 2-Aminobenzoate | 87-25-2 |
| Ethyl Cinnamate | 103-36-6 |
| Ethyl n-Valerate | 539-82-2 |
| Ethyl Phenylacetate | 101-97-3 |
| Ethyl Salicylate | 118-61-6 |
| Ethyl Sulfide | 352-93-2 |
| Ethyl Vanillin | 121-32-4 |
| Ethylene Mercaptan | 540-63-6 |
| Farnesene | 502-61-4 |
| Folic acid | 59-30-3 |
| gamma-Nonanolactone | 104-61-0 |
| gamma-Valerolactone | 108-29-2 |
| Gluconic Acid | 526-95-4 |
| Gluconic Acid Potassium Salt | 299-27-4 |
| Glutaric Acid | 110-94-1 |
| Guanosine-5′-monophosphate, | 1333479 |
| disodium salt | |
| Heliotropine | 120-57-0 |
| Hippuric Acid | 495-69-2 |
| Hydroquinone Dimethyl Ether | 150-78-7 |
| Inosine-5′-monophosphate | 4691-65-0 |
| Sodium Salt | |
| iso-Amyl Mercaptan | 541-31-1 |
| Isoamyl Salicylate | 87-20-7 |
| iso-butyl n-Hexanoate | 105-79-3 |
| isovaleraldehyde | 590-86-3 |
| Isoamyl Benzoate | 94-46-2 |
| Isoamyl Formate | 110-45-2 |
| Isoamyl n-Butyrate | 106-27-4 |
| Isoamylamine | 107-85-7 |
| Isobutyl n-Butyrate | 539-90-2 |
| Isocaproic Acid | 646-07-1 |
| Isoeugenol | 97-54-1 |
| Isopropyl Benzoate | 939-48-0 |
| Isopropyl Formate | 625-55-8 |
| Isopropyl N-Butyrate | 638-11-9 |
| Isopropyl Propionate | 637-78-5 |
| isobutyl Mercaptan | 513-44-0 |
| L-(+)-Isoleucine | 73-32-5 |
| L-(−)-Apple Acid | 97-67-6 |
| L-2-Aminopropionic Acid | 56-41-7 |
| L-Aspartic acid | 56-84-8 |
| L-Carnitine | 541-15-1 |
| L-Cysteine Hydrochloride | 52-89-1 |
| L-Glutamic Acid Hydrochloride | 138-15-8 |
| L-Glutamine | 56-85-9 |
| L-Hydroxyproline | 51-35-4 |
| L-Proline | 147-85-3 |
| L-Serine | 56-45-1 |
| L-Threonine | 72-19-5 |
| L-Valine | 72-18-4 |
| N-Acetylglycine | 543-24-8 |
| n-Amyl Formate | 638-49-3 |
| n-Amyl n-Caproate | 540-07-8 |
| n-Butyl n-Caproate | 626-82-4 |
| n-Butyl Propionate | 590-01-2 |
| n-Butyl Salicylate | 2052-14-4 |
| n-Decanoic Acid | 334-48-5 |
| n-Hexyl Mercaptan | 111-31-9 |
| n-Proply Benzoate | 2315-68-6 |
| n-Propyl Isobutyrate | 644-49-5 |
| n-Tetradecanoic Acid | 544-63-8 |
| Nitrilotriacetic Acid | 5064-31-3 |
| Trisodium Salt | |
| o-Tolunethiol | 137-06-4 |
| Orotic Acid | 65-86-1 |
| p-Acetamidobenzoic Acid | 556-08-1 |
| p-Anise Alcohol | 105-13-5 |
| Phenoxyacetic Acid | 122-59-8 |
| Phenyl Acetate | 122-79-2 |
| Piperine | 94-62-2 |
| Pivalic Acid | 75-98-9 |
| Potassium Benzoate | 528-25-2 |
| Potassium Diphosphate | 7320-34-5 |
| Potassim Hypophosphite | 7782-87-8 |
| Potassium Metaphosphate | 7790-53-6 |
| Potassium Sulfite | 10117-38-1 |
| Quinine Hydrochloride | 130-89-2 |
| sec-Amyl Alcohol | 6032-29-7 |
| Sodium D-Pantothenate | 867-81-2 |
| Di(2-ethylhexyl) sulfosuccinic | 577-11-7 |
| acid, sodium salt | |
| Sodium Sorbate | 7757-81-5 |
| Succinic acid, disodium salt | 150-90-3 |
| Sodium Taurocholate | 145-42-6 |
| Taurine | 107-35-7 |
| Thiamine Nitrate | 532-43-4 |
| Thioanisole | 100-68-5 |
| Tiglic Acid | 80-59-1 |
| Tri-n-butyrin | 60-01-5 |
| Triacetin | 102-76-1 |
| Trisodium Citrate | 68-04-2 |
| Veratraldehyde | 120-14-9 |
| Veratrole | 91-16-7 |
| Vitamin P | 520-26-3 |
| Vitamin U Chloride | 582174 |
| L-Methionine | 63-68-3 |
| 2-Chloro-1-propanol | 78-89-7 |
| 2-Ethylbutyric acid | 88-09-5 |
| 2-Methylbutyraldehyde | 96-17-3 |
| 2-Methyl-5-ethylpyridine | 104-90-5 |
| n-propyl butyrate | 105-66-8 |
| Ethyl caprylate | 106-32-1 |
| Propyl propionate | 106-36-5 |
| 2-Methylpyrazine | 109-08-0 |
| 3,3,5-Trimethyl-1-cyclohexanol | 116-02-9 |
| Ethyl caproate | 123-66-0 |
| o-methoxybenzaldehyde | 135-02-4 |
| 2,4-Hexadienal | 142-83-6 |
| 3-Hexanone | 589-38-8 |
| 3-Methyl-2-butanol | 598-75-4 |
| Methyl isopropenyl ketone | 814-78-8 |
| 3-Methyl-2-butanethiol | 2084-18-6 |
| 3,5,5-Trimethylhexanol | 3452-97-9 |
| Methylglyoxal | 78-98-8 |
| Malonaldehyde | 542-78-9 |
| 1,4-Dithiane | 505-29-3 |
| Amylcinnamaldehyde | 122-40-7 |
| Benzyl cinnamate | 103-41-3 |
| tert-Butylhydroquinone | 1948-33-0 |
| Fusidic Acid Sodium Salt | 751-94-0 |
| Hydroxycitronellal | 107-75-5 |
| Musk ketone | 81-14-1 |
| L-Asparagine | 70-47-3 |
| phenethyl acetate | 103-45-7 |
| Riboflavin 5-Phosphate | 146-17-8 |
| Potassium Sodium Tartrate | 304-59-6 |
| Galactaric acid | 526-99-8 |
| Sodium Tartrate | 868-18-8 |
| Trisodium phosphate | 7601-54-9 |
| Disodium Pytophosphate | 7758-16-9 |
| Magnesium chloride | 7786-30-3 |
| Sodium Polymethacrylate | 54193-36-1 |
| propiophenone | 93-55-0 |
| 2-ethylhexanoic acid | 149-57-5 |
| 3,7,7-trimethyl bicyclohep-3- | 13466-78-9 |
| ene | |
| 2,6-dimethyl-4-heptanol | 108-82-7 |
| 5-isopropyl-2-methyl-phenol | 499-75-2 |
| L-Bomyl acetate | 5655-61-8 |
| caryophyllene | 87-44-5 |
| hydroxymethylpyrone | 118-71-8 |
| neosperidin dihydrochalcone | 20702-77-6 |
| 2,2-Dibromo-3- | 10222-01-2 |
| nitrilopropionamide | |
| Xylitol | 87-99-0 |
| Sulfosalicylic acid | 97-05-2 |
| Riboflavin 5′-(dihydrogen | 130-40-5 |
| phosphate), monosodium salt | |
| Ethylenediaminetetraacetic | 139-33-3 |
| acid, disodium salt | |
| Gallic acid | 149-91-7 |
| Carbonic acid | 463-79-6 |
| Potassium carbonate, | 6381-79-9 |
| sesquihydrate | |
| Magnesium phosphate tribasic | 7757-87-1 |
| diallyl sulfide | 592-88-1 |
| ethyl 4-oxopentanoate | 539-88-8 |
| methyl caproate | 106-70-7 |
| isopropyl isobutyrate | 617-50-5 |
| diethyl hydroxybutanedioate | 2065419 |
| propyl isopentanoate | 557-00-6 |
| benzyl ethyl ether | 539-30-0 |
| isobutyl isopentanoate | 589-59-3 |
| propyl hexanoate | 626-77-7 |
| 4-methylquinoline | 491-35-0 |
| methyl cinnamate | 103-26-4 |
| cumic alcohol | 536-60-7 |
| thujone | 471-15-8 |
| dihydrocarveol | 619-01-2 |
| fenchyl alcohol | 1632-73-1 |
| Nerol | 106-25-2 |
| isopentyl isopentanoate | 659-70-1 |
| methyleugenol | 93-15-2 |
| methyl 2-naphtyl ketone | 93-08-3 |
| diphenyldisulfide | 882-33-7 |
| citronellyl acetate | 150-84-5 |
| menthyl acetate | 89-48-5 |
| menthyl isovalerate | 16409-46-4 |
| 5-Ethyl-3-hydroxy-4-methyl- | 698-10-2 |
| 2(5H)-furanone | |
| malic acid | 6915-15-7 |
| 3-methylbutanoic acid butyl | 109-19-3 |
| ester | |
| 3-phenyloxiranecarboxylic acid | 121-39-1 |
| ethyl ester | |
| 1,2-Benzisothiazol-3(2H)-one | 6381-61-9 |
| 1,1-dioxide, ammonium salt | |
| 1-methyl-4-(1-methylethyl)- | 99-85-4 |
| 1,4-Cyclohexadiene | |
| 3-mercapto-2-Butanol | 54812-86-1 |
| (1R)-2,6,6- | 7785-70-8 |
| trimethylbicyclo[3.1.1]hept-2- | |
| ene | |
| (1S)-6,6-dimethyl-2- | 18172-67-3 |
| methylenebicyclo[3.1.1]heptane | |
| 1-methyl-4-)1- | 586-62-9 |
| methylethylidene)cyclohexene | |
| 1-(3-pyridinyl)ethanone | 350-03-8 |
| 1-pyrazinylethanone | 22047-25-2 |
| 1-(2-furyl)-2-propanone | 6975-60-6 |
| 1-Penten-3-one | 1629-58-9 |
| 2,3-pentanedione | 600-14-6 |
| 2,5-dimethylpyrazine | 123-32-0 |
| 2-isobutyl-3-methoxypyrazine | 24683-00-9 |
| 4-methyl-2,3-pentanedione | 7493-58-5 |
| 5-methylfurfural | 620-02-0 |
| Dimethyltrisulfide | 3658-80-8 |
| furfuryl acetate | 623-17-6 |
| furfurylmethylether | 13679-46-4 |
| terpinen-4-ol | 562-74-3 |
| Calcium sorbate | 7492-55-9 |
| Potassium lactate | 996-31-6 |
| 1-Hydroxyethylidene-1,1- | 2809-21-4 |
| diphosphonic acid | |
| L-glutamic acid monopotassium | 19473-49-5 |
| salt | |
| 3-methyl-2-buten-1-ol | 556-82-1 |
| phenylethanal | 122-78-1 |
| 4′-Methoxyacetophenone | 100-06-1 |
| L-borneol | 464-45-9 |
| 2,4-Hexadien-1-ol | 111-28-4 |
| D-Fenchone | 4695-62-9 |
| 3-Phenylpropyl formate | 104-64-3 |
| Cinnamyl formate | 104-65-4 |
| D-galacturonate | 685-73-4 |
| D-glucuronate | 1700908 |
| 5′ IMP | 131-99-7 |
| 1-Methoxy-4-methylbenzene | 104-93-8 |
| 2-Methylbutanoic acid | 116-53-0 |
| 2,4,6-Tribromophenol | 118-79-6 |
| 3-Ethyl pyridine | 536-78-7 |
| Zinc acetate | 557-34-6 |
| Methyl pentanoate | 624-24-8 |
| Methylthioethane | 624-89-5 |
| 3-Penten-2-one | 625-33-2 |
| Glyocholic acid | 475-31-0 |
| m-Methoxybenzoic acid | 586-38-9 |
| alpha-Hydroxypropionic acid | 598-82-3 |
| Methyl 2-furoate | 611-13-2 |
| 2-Furancarboxylic acid, propyl | 615-10-1 |
| ester | |
| Benzylacetoscetic acid, ethyl | 620-79-1 |
| ester | |
| 2,5-Dimethyl pyrrole | 625-84-3 |
| 4-methyl-1,1′-biphenyl | 644-08-6 |
| pisopropylacetophenone | 645-13-6 |
| 4-methyl-thiazole | 693-95-8 |
| gamma-Decalactone | 706-14-9 |
| 2-aceltylpyrrole | 1072-83-9 |
| 2-acetylpyridine | 1122-62-9 |
| tetramethyl-pyrazine | 1124-11-4 |
| Methyl 4-phenylbutyrate | 2046-17-5 |
| 2,3,6-trimethyl-phenol | 2416-94-6 |
| 2-Methoxypyrazine | 3149-28-8 |
| 2-Ethylfuran | 3208-16-0 |
| 2,3-dimethyl-pyrazine | 5910-89-4 |
| Thiophenethiol | 7774-74-5 |
| o-Tolyl isobutyrate | 36438-54-7 |
| cis-3-Hexenyl pyruvate | 68133-76-6 |
| cis-3-Hexenyl cis-3-hexenoate | 61444-38-0 |
| trans-2-Hexenyl isovalerate | 68698-59-9 |
| trans-2-Hexenyl formate | 53398-78-0 |
| trans-2-Hexenyl valerate | 56922-74-8 |
| 1-Octen-3-yl butyrate | 16491-54-6 |
| Methyl 4-(methylthio)butyrate | 53053-51-3 |
| 2,4-Octadien-1-ol | 18409-20-6 |
| 2,4-Nonadien-1-ol | 62488-56-6 |
| 2,4-Decadien-1-ol | 18409-21-7 |
| (e,z)-2,6-Nonadienyl acetate | 68555-65-7 |
| 3-Hexenal | 4440-65-7 |
| Tetrahydro-2-furanmethanol | 637-64-9 |
| acetate | |
| Methyl benzaldehyde | 1334-78-7 |
| Dodecylsulfonic acid | 1510-16-3 |
| Methylethyl disulfide | 4253-89-8 |
| Farnesol | 4602-84-0 |
| Thiobenzoic acid, S-methyl | 5925-68-8 |
| ester | |
| Hexyl benzoate | 6789-88-4 |
| 2,5-Diethyltetrahydrofuran | 41239-48-9 |
| Zinc hydrosulfite | 7779-86-4 |
| (2R,3S)-Tartaric Acid | 147-73-9 |
| Ethylsufuric acid | 540-82-9 |
| 1,2,2-Trimethyl-1,3- | 5394-83-2 |
| cyclopentanedicarboxylic acid | |
| 2-Methyl-3-buten-2-ol | 115-18-4 |
| trans-2-Hexenal | 6728-26-3 |
| 4-Hexen-3-one | 2497-21-4 |
| 1-Hexen-3-ol | 4798-44-1 |
| 2-Methyl-1-butanethiol | 1878-18-8 |
| 4-Methylcyclohexanone | 589-92-4 |
| 3-Heptanol | 589-82-2 |
| o-methylanisole | 578-58-5 |
| trans-2-octenal | 2363-89-5 |
| 2,3,4-Trimethyl-3-pentanol | 3054-92-0 |
| Acetylacetaldehyde dimethyl | 5436-21-5 |
| acetal | |
| p-methylacetophernone | 122-00-9 |
| o-aminoacetophenone | 551-93-9 |
| 4-Propylphenol | 645-56-7 |
| 2,4-Dimethylanisole | 6738-23-4 |
| Benzyl methyl sulfide | 766-92-7 |
| Methyl penylacetate | 101-41-7 |
| 4-Ethoxybenzaldehyde | 10031-82-0 |
| p-tolyl acetate | 140-39-6 |
| 2,6-Dimethoxyphenol | 91-10-1 |
| Isoborneol | 124-76-5 |
| Methyl 2-methoxybenzoate | 606-45-1 |
| Phenylacetaldehyde dimethyl | 101-48-4 |
| acetal | |
| 3-Phenylpropyl acetate | 122-72-5 |
| Ethyl 3-phenylpropionate | 2021-28-5 |
| Benzyl butyrate | 103-37-7 |
| Anisyl acetate | 104-21-2 |
| Isobutyl phenylacetate | 102-13-6 |
| p-vinylphenol | 2628-17-3 |
| o-tolyl acetate | 533-18-6 |
| 2,5-Dihydroxybenzoic acid | 490-79-9 |
| o-methoxyphenyl acetate | 613-70-7 |
| Lactobionic acid | 96-82-2 |
| Magnesium hydrogen | 7782-75-4 |
| phosphate | |
| trihydrate | |
| Iberverin | 505-79-3 |
| alpha-methylcinnamaldehyde | 101-39-3 |
| benzyl phenylacetate | 102-16-9 |
| 1,3-dimercaptopropane | 109-80-8 |
| p-cymen-8-ol | 1197-01-9 |
| phenethyl antranilate | 133-18-6 |
| trihydroxybutyrophenone | 1421-63-2 |
| o-methoxycinnamaldehyde | 1504-74-1 |
| 3-propylidene phthalide | 17369-59-4 |
| trans,trans-2,4-decadienal | 25152-84-5 |
| piperonyl acetate | 326-61-4 |
| 2,3-hexanedione | 3848-24-6 |
| isopropyl phenylacetate | 4861-85-2 |
| ethyl 3-hydroxybutyrate | 5405-41-4 |
| furfural acetone | 623-15-4 |
| beta-(2-furyl)acrolein | 623-30-3 |
| linalyl anthranilate | 7149-26-0 |
| citral diethyl acetal | 7492-66-2 |
| allyl anthranilate | 7493-63-2 |
| acetyl tributyl citrate | 77-90-7 |
| butyl anthranilate | 7756-96-9 |
| cyclohexyl anthranilate | 7779-16-0 |
| isoamyl cinnamate | 7779-65-9 |
| isobutyl anthranilate | 7779-77-3 |
| carvyl acetate | 97-42-7 |
| carveol | 99-48-9 |
| 3-(Methylthio)propionaldehyde | 3268-49-3 |
| Alpha-damascone | 43052-87-5 |
| Dimethyldicarbonate | 4525-33-1 |
| Procaine | 59-46-1 |
| 5-hydroxy-6-methyl-3,4- | 65-23-6 |
| pyridinedimethanol | |
| 2-methoxy-Naphthalene | 93-04-9 |
| Methyl nicotinate | 93-60-7 |
| Ethyl benzoylacetate | 94-02-0 |
| Phenethyl benzoate | 94-47-3 |
| 2-methyl-pentanoic acid | 97-61-0 |
| Cyclohexanecarboxylic acid | 98-89-5 |
| Methyl b-phenylpropionate | 103-25-3 |
| Benzyl 3-methyl butanoate | 103-38-8 |
| Naphthalene-2-sulfonic acid | 120-18-3 |
| Methyl 4-methoxybenzoate | 121-98-2 |
| 3-Phenylprop-2-enyl cinnamate | 122-69-0 |
| 7-methyl-3-methylene-1,6- | 123-35-3 |
| Octadiene | |
| Levulinic acid | 123-76-2 |
| 2-Mercaptobenzoic acid | 147-93-3 |
| m-Dimethoxybenzene | 151-10-0 |
| 3-butyl-1(3H)-isobenzofuranone | 6066-49-5 |
| 5-Methylquinoxaline | 13708-12-8 |
| 2-Ethyl Pyrazine | 13925-00-3 |
| trimethyl-pyrazine | 14667-55-1 |
| 2-ethyl-3-methyl-pyrazine | 15707-23-0 |
| 2,3-diethyl-pyrazine | 15707-24-1 |
| 2,3-diethyl-5-methyl-pyrazine | 18138-04-0 |
| 2-Methylthiopyrazine | 21948-70-9 |
| 5-Methyl-3H-furan-2-one | 591-12-8 |
| cis-3-Hexen-1-ol | 928-96-1 |
| 3,7-Dimethyl-1,3,6-octatriene | 13877-91-3 |
| calcium cyclamate | 139-06-0 |
| aconitic acid | 499-12-7 |
| 2-Dehydrolinalool | 29171-20-8 |
| 2-Mercaptopropionic acid | 79-42-5 |
| 3-Methyl-2-butenal | 107-86-8 |
| Allylacetic acid | 591-80-0 |
| Allyl cyclohexylacetate | 4728-82-9 |
| Allyl cyclohexylpropionate | 2705-87-5 |
| Allyl phenoxyacetate | 7493-74-5 |
| Allyl phenylacetate | 1797-74-6 |
| Allyl alpha-ionone | 79-78-7 |
| Butyl butyrolactate | 7492-70-8 |
| Cinnamyl isobutyrate | 103-59-3 |
| Cinnamyl propionate | 103-56-0 |
| Dibenzyl disulfide | 150-60-7 |
| Isobornyl acetate | 125-12-2 |
| Methyl heptyne carbonate | 111-12-6 |
| Triethyl citrate | 77-93-0 |
| gamma-Undecalactone | 104-67-6 |
| alpha-Amylcinnamyl alcohol | 101-85-9 |
| 1,3,4,6,7,8-Hexahydro- | 1222-05-5 |
| 4,6,6,7,8,8-hexanmethyl | |
| cyclopenta[g] [2]benzopyran | |
| 2-Ethylbutyl acetate | 10031-87-5 |
| Triphosphoric acid, | 13845-36-8 |
| pentapotassium salt | |
| L-(+)-Lactic acid | 79-33-4 |
| Mannitol | 87-78-5 |
| 2-Methoxy-4-methylphenol | 93-51-6 |
| 1,2,3-Propanetricarboxylic acid, | 144-33-2 |
| 2-hydroxy-, disodium salt | |
| Ethanesulfonic acid, 2-hydroxy-, | 1562-00-1 |
| monosodium salt | |
| 2-Methoxy-4-propylphenol | 2785-87-7 |
| 3,7-Dimethyl-3-octanol | 78-69-3 |
| 2-Pentyl furan | 3777-69-3 |
| Butanoic acid, 3-oxo-, butyl | 591-60-6 |
| ester | |
| 4-(4-Hydroxy-4-methyl pentyl)-3- | 31906-04-4 |
| cyclohexene-1-carboxaldehyde | |
| Methyl 3-oxo-2- | 24851-98-7 |
| pentylcyclopentanescetate | |
| Naphthalene, 2-(2- | 2173-57-1 |
| methylpropoxy)- | |
| Perillol | 536-59-4 |
| 2-Acetyl-1-methylpyrrole | 932-16-1 |
| 4-Allyl-2,6-dimethoxyphenol | 6627-88-9 |
| Butyl levulinate | 2052-15-5 |
| D-(+)-Camphoric acid | 124-83-4 |
| D(+)-10-Camphorsulfonic acid | 3144-16-9 |
| L-(−)-Carvone | 6485-40-1 |
| (−)-Carvyl propionate | 97-45-0 |
| (−)-Caryophyllene oxide | 1139-30-6 |
| Cyclohexylacetic acid | 5292-21-7 |
| 3-Cyclopentylpropionic acid | 140-77-2 |
| (−)-Dihydrocarvyl acetate | 20777-49-5 |
| 3,3-Dimethylacrylic acid | 541-47-9 |
| 2,4-Dimethylbenzaldehyde | 15764-16-6 |
| 1,4-Dithiane-2,5-diol | 40018-26-6 |
| Ethanesulfonic acid | 594-45-6 |
| Ethyl butyrylacetate | 3249-68-1 |
| Ethyl (methylthio) acetate | 4455-13-4 |
| Ethyl pyruvate | 617-35-6 |
| Ethyl sorbate | 2396-84-1 |
| 5-Formyl-2-furansulfonic acid, | 31795-44-5 |
| sodium salt | |
| Furfuryl mercaptan | 98-02-2 |
| 1,6-Hexanedithiol | 1191-43-1 |
| trans-2-Hexenoic acid | 13419-69-7 |
| trans-2-Hexen-1-ol | 928-95-0 |
| 4-(4-Hydroxyphenyl)-2-butanone | 5471-51-2 |
| Isopulegol | 89-79-2 |
| Isopulegyl acetate | 89-49-6 |
| 2-Ketobutyric acid | 600-18-0 |
| (−)-Limonene | 5989-54-8 |
| 4-Methoxyphenylacetone | 122-84-9 |
| Methyl cyclohexanecarboxylate | 4630-82-4 |
| 3-Methylcyclohexanone | 591-24-2 |
| 3-Methyl-2-cyclohexen-1-one | 1193-18-6 |
| 3-Methyl-1,2-cyclopentanedione | 765-70-8 |
| 3-Methyl-2-cyclopenten-1-one | 2758-18-1 |
| N-Methyl-D-glucamine | 6284-40-8 |
| Methyl 3-(methylthio)propionate | 13532-18-8 |
| 4-Methyl-5-thiazoleethanol | 137-00-8 |
| 5-Methyl-2- | 13679-70-4 |
| thiophenecarboxaldehyde | |
| DL-3-Methylvaleric acid | 105-43-1 |
| (−)-Myrtenal | 564-94-3 |
| Nopol | 128-50-7 |
| gamma-Octanoic lactone | 104-50-7 |
| 3-Octanol | 589-98-0 |
| E-2-Octenoic acid | 1871-67-6 |
| Pamoic acid | 130-85-8 |
| 4-Phenyl-2-butyl acetate | 10415-88-0 |
| 1-Phenyl-1,2-propanedione | 579-07-7 |
| 2-Phenylpropyl butyrate | 80866-83-7 |
| 2-Phenylpropyl isobutyrate | 65813-53-8 |
| cis-2-Hexen-1-ol | 928-94-9 |
| Bis(methylthio)methane | 1618-26-4 |
| Magnesium carbonate | 39409-82-0 |
| hydroxide, Light | |
| N-Acetyl-L-methionine | 65-82-7 |
| 4-Methyl-5-vinylthiazole | 1759-28-0 |
| 2-Methyl-1-phenyl-2-propanol | 100-86-7 |
| 3-Phenylpropionaldehyde | 104-53-0 |
| N-Benzyl-2-phenylethylamine | 3647-71-0 |
| 1-Phenylethyl propionate | 120-45-6 |
| 3-Phenylpropyl isobutyrate | 103-58-2 |
| Allyl hexanoate | 123-68-2 |
| alpha, 4-Dimethylbenzylalcohol | 536-50-5 |
| (−)-Menthyl lactate | 59259-38-0 |
| 2,6-Dimethylthiophenol | 118-72-9 |
| 2,4,5-Trimethylthiazole | 13623-11-5 |
| Ethyl 3-(methylthio)propionate | 13327-56-5 |
| Phenylethyl isovalerate | 140-26-1 |
| 2-Propylpyrazine | 18138-03-9 |
| 2-Methyltetrahydrofuran-3-one | 3188-00-9 |
| Ethyl 2-(methyldithio)propionate | 23747-43-5 |
| 3,4-(Dimethyl-1,2- | 13494-06-9 |
| cyclopentanedione | |
| Difurfurylsulfide | 13678-67-6 |
| Difurfuryldisulfide | 4437-20-1 |
| 3-(Methylthio)propanol | 505-10-2 |
| Methyl phenyl disulfide | 14173-25-2 |
| 2-(Methyldithio)- | 67952-60-7 |
| isobutyraldehyde | |
| Methyl 2-thiofuroate | 13679-61-3 |
| 2-Isobutylthiazole | 18640-74-9 |
| 4-Methyl-5-thiazolylethyl acetate | 656-53-1 |
| 2-Acetylthiazole | 24295-03-2 |
| 2-Ethyl-3,5(6)-dimethylpyrazine | 27043-05-6 |
| 5-Methyl-6,7-dihydro-5H- | 23747-48-0 |
| cyclopenta(b)pyrazine | |
| Cinnamyl acetate | 103-54-8 |
| 2,5-Dihydroxy-2,5-dimethyl-1,4- | 55704-78-4 |
| dithiane | |
| 5,6,7,8-Tetrahydroquinoxaline | 34413-35-9 |
| 2-Methyl-3-furanethiol | 28588-74-1 |
| Styrallyl acetate | 93-92-5 |
| 2-Methylhexanoic acid | 4536-23-6 |
| 2-Methylheptanoic acid | 1188-02-9 |
| 2,2,6-Trimethylcycloheanone | 2408-37-9 |
| L-Tyrosine ethyl ester | 4089-07-0 |
| hydrochloride | |
| Ethyl 4-methoxybenzoate | 94-30-4 |
| 4-Ethylbenzaldehyde | 4748-78-1 |
| N-Ethyl-p-menthane-3- | 39711-79-0 |
| carboxamide | |
| 1-(2-Furyl)-1,3-butanedione | 25790-35-6 |
| Menthofuran | 494-90-6 |
| Methylsulfuric acid sodium salt | 512-42-5 |
| Sucrose diacetate | 126-13-6 |
| hexaisobutyrate | |
| N,2,3-Trimethyl-2- | 51115-67-4 |
| isopropylbutamide | |
| Tripropionin | 139-45-7 |
| (+/−)-Citronellic acid | 502-47-6 |
| 5-Acetyl-2,4-dimethylthiazole | 38205-60-6 |
| Neryl acetate | 141-12-8 |
| Benzyl propionate | 122-63-4 |
| 1R-(−)-Camphorsulfonic acid | 35963-20-3 |
| 3,4-Hexanedione | 4437-51-8 |
| cis-3-Hexenoic acid | 4219-24-3 |
| cis-4-Heptenal | 6728-31-0 |
| (E,Z)-2,6-nonadienal | 557-48-2 |
| trans-2,trans-6-Nonadienal | 17587-33-6 |
| 4-Methyl-2-pentenal | 5362-56-1 |
| cis-6-Nonenal | 2277-19-2 |
| Methyl propyl disulfide | 2179-60-4 |
| 8-p-Menthen-1-ol | 138-87-4 |
| p-Menthan-2-one | 499-70-7 |
| Bisabolene | 495-62-5 |
| Ethyl cyclohexanecarboxylate | 3289-28-9 |
| Phenylpyruvate | 156-06-9 |
| Hydroxypyruvate | 1113-60-6 |
| 4-Methyl-2-oxopentanoate | 816-66-0 |
| (+)-Neomenthol | 2216-52-6 |
| trans-Citral | 141-27-5 |
| Piperitenone | 491-09-8 |
| Sabinene hydrate | 546-79-2 |
| Perillyl aldehyde | 2111-75-3 |
| 2-Hydroxyethanesulfonate | 107-36-8 |
| Acetyl isovaleryl | 13706-86-0 |
| Acetyl valeryl | 96-04-8 |
| Butylidene phthalide | 551-08-6 |
| Carvacryl ethyl ether | 4732-13-2 |
| Ethyl vanillin propylene glycol | 68527-76-4 |
| acetal | |
| Hexyl hexanoate | 6378-65-0 |
| 2-Methyl-5-(methylthio)-furan | 13678-59-6 |
| 2-Methyl-4-pentenoic acid | 1575-74-2 |
| 2-Methyl-4-propyl-1,3-oxathiane | 67715-80-4 |
| 3-Methylthio-1-hexanol | 51755-66-9 |
| cis-6-Nonenol | 35854-86-5 |
| Rose oxide | 16409-43-1 |
| L-Linalool | 126-91-0 |
| 5,6-Dimethyl-8- | 4674-50-4 |
| isopropenylbicyclo[4,4,0]dec-1- | |
| en-3-one | |
| 2-Ethyl-3,5-dimethylpyrazine | 13925-07-0 |
| 2-Isopropylpyrazine | 29460-90-0 |
| 2-Isobutyl-3-methyl-pyrazine | 13925-06-9 |
| 2-Methoxy-3-sec-butyl-pyrazine | 24168-70-5 |
| 2-Methylthio-3(6)-methyl- | 67952-65-2 |
| pyrazine | |
| Benzylcarbinyl propionate | 122-70-3 |
| Bornyl acetate | 76-49-3 |
| furaneol | 3658-77-3 |
| Methoxycinnamaldehyde | 1963-36-6 |
| Methylphenol, hydrogen sulfate | 68127-34-4 |
| Lactitol monohydrate | 81025-04-9 |
| 2H-Pyrrole, 3,4-dihydro- | 5724-81-2 |
| 2-Butenal, 2-methyl-, (E)- | 497-03-0 |
| 2-Pentenal | 764-39-6 |
| Ethanethioic acid, S-methyl | 1534-08-3 |
| ester | |
| 2-Hexenal | 505-57-7 |
| 2-Methyl-2-pentenal | 623-36-9 |
| Cyclopentanethiol | 1679-07-8 |
| Butane, 2-ethoxy- | 2679-87-0 |
| S-Ethyl thioacetate | 625-60-5 |
| ethyl methyl carbonate | 623-53-0 |
| 3(2H)-Furanone, 2,5-dimethyl- | 14400-67-0 |
| Allyl propionate | 2408-20-0 |
| methyl 2-methylbutanoate | 868-57-5 |
| 2-Butanone, 1-(methylthio)- | 13678-58-5 |
| Ethanethioic acid, S-propyl ester | 2307-10-0 |
| 1,2-Butanedithiol | 16128-68-0 |
| 6-Methyl-3,5-heptadiene-2-one | 1604-28-0 |
| 2-Octen-4-one | 4643-27-0 |
| 2,5-dimethyl-3-furanthiol | 55764-23-3 |
| 2-Heptenoic acid | 189999-28-5 |
| Butanoic acid, 2-propenyl ester | 2051-78-7 |
| 6-Methyl-5-hepten-2-ol | 1569-60-4 |
| trans-2-Octen-4-ol | 20125-81-9 |
| cis-3-Octen-1-ol | 20125-84-2 |
| 1-Butanol, 2-methyl-, acetate | 624-41-9 |
| 4-methyl-alpha-methylstyrene | 1195-32-0 |
| trans-3-Phenyl-2-propen-1-ol | 4407-36-7 |
| Benzeneacetaldehyde, alpha- | 93-53-8 |
| methyl- | |
| Benzene, (2-methoxyethyl)- | 3558-60-9 |
| Cyclohexene, 1-methyl-4-(1- | 7705-14-8 |
| methylethenyl)-, (+−)- | |
| Phenol, 2-(methylthio)- | 1073-29-6 |
| 2-Hexen-1-yl acetate | 2497-18-9 |
| 3-Hexen-1-ol, acetate, (Z)- | 3681-71-8 |
| 5-Hydroxy-4-octanone | 496-77-5 |
| butyl 2-methylpropanoate | 97-87-0 |
| Benzofuran-2-carboxaldehyde | 4265-16-1 |
| DL-Lysine | 70-54-2 |
| 1-Hexanethiol, 2-ethyl- | 7341-17-5 |
| 2′,4′-Dimethylacetophenone | 89-74-7 |
| 2-Pentylpyridine | 2294-76-0 |
| 1-Methoxy-4-propyl benzene | 104-45-0 |
| 1-Hydroxy-2-methoxy-4-ethyl | 2785-89-9 |
| benzene | |
| Nonalactone | 6008-27-1 |
| Cyclohexyl propionate | 6222-35-1 |
| Allyl 2-ethylbutyrate | 7493-69-8 |
| Butanoic acid, 3-oxo-, 2- | 7779-75-1 |
| methylpropyl ester | |
| n-Butyl pentanoate | 591-68-4 |
| 3,7-Dimethyl-1-octanol | 106-21-8 |
| 3-Buten-2-one, 3-methyl-4- | 1901-26-4 |
| phenyl- | |
| 2-Propenoic acid, 3-phenyl-, | 1754-62-7 |
| methyl ester, (E)- | |
| Benzene, 4-ethenyl-1,2- | 6380-23-0 |
| dimethoxy- | |
| Benzenepropanol, alpha,alpha- | 103-05-9 |
| dimethyl- | |
| Benzene, (butoxymethyl)- | 588-67-0 |
| Dimethyl anthranilate | 85-91-6 |
| 2-Hexanoylfuran | 14360-50-0 |
| Cyclohexyl butyrate | 1551-44-6 |
| Naphthalene, 2-ethoxy- | 93-18-5 |
| Acetoacetic acid isoamyl ester | 2308-18-1 |
| Propanoic acid, 2-methyl-, 4- | 103-93-5 |
| methylphenyl ester | |
| 4-(4-Methoxyphenyl)-2- | 104-20-1 |
| butanone | |
| Isobutyl benzoate | 120-50-3 |
| Benzene, 1,2-dimethoxy-4-(1- | 93-16-3 |
| propenyl)- | |
| beta- | 10415-87-9 |
| Phenylethylmethylethylcarbinol | |
| 1,1-Dimethoxy-2-phenylpropane | 90-87-9 |
| Geranyl formate | 105-86-2 |
| Bornyl formate | 7492-41-3 |
| 6-Octen-1-ol, 3,7-dimethyl-, | 105-85-1 |
| formate | |
| Benzeneacetic acid, butyl ester | 122-43-0 |
| 3,5,9-Undecatrien-2-one, 6,10- | 141-10-6 |
| dimethyl- | |
| Anisyl propionate | 7549-33-9 |
| Butanoic acid, 3-phenyl-2- | 103-61-7 |
| propenyl ester | |
| 2-Propenoic acid, 3-phenyl-, 2- | 122-67-8 |
| methylpropyl ester | |
| Eugenyl acetate | 93-28-7 |
| 3-Methylbutyl phenylacetate | 102-19-2 |
| Benzoic acid, 2-(methylamino)-, | 65505-24-0 |
| 2-methylpropyl ester | |
| Phenoxy ethyl isobutyrate | 103-60-6 |
| Anisyl butyrate | 6963-56-0 |
| 2,6-Octadien-1-ol, 3,7-dimethyl-, | 105-91-9 |
| propanoate, (Z)- | |
| Isobornyl propionate | 2756-56-1 |
| 1,3,5-Trithiane, 2,2,4,4,6,6- | 828-26-2 |
| hexamethyl- | |
| Geranyl N-butyrate | 106-29-6 |
| Geranyl isobutyrate | 2345-26-8 |
| Thiophene, 2,2′-dithiobis- | 6911-51-9 |
| 2-Propenoic acid, 3-phenyl-, | 7779-17-1 |
| cyclohexyl ester | |
| Benzeneacetic acid, 3-phenyl-2- | 7492-65-1 |
| propenyl ester | |
| Anisyl phenylacetate | 102-17-0 |
| 2-Propenoic acid, 3-phenyl-, 3- | 122-68-9 |
| phenylpropyl ester | |
| Geranyl phenylacetate | 102-22-7 |
| hexyl 2-methylbutyrate | 10032-15-2 |
| 4-heptanolide | 105-21-5 |
| Neral | 106-26-3 |
| (E)-2-octenol | 18409-17-1 |
| Ethyl 3-hydroxyhexanoate | 2305-25-1 |
| isopropyl hexanoate | 2311-46-8 |
| hexyl butanoate | 2639-63-6 |
| bis(2-methyl-3-furyl)disulfide | 28588-75-2 |
| 3-hydroxy-4,5-dimethyl-2(5H)- | 28664-35-9 |
| furanone | |
| 2-acetyl-2-thiazoline | 29926-41-8 |
| (E,E)-2,4-octadienal | 30361-28-5 |
| geranyl acetone | 3796-70-1 |
| 1-octen-3-one | 4312-99-6 |
| 3-mercapto-2-pentanone | 67633-97-0 |
| (Z)-3-hexenal | 6789-80-6 |
| 4-hexanolide | 695-06-7 |
| 5-octanolide | 698-76-0 |
| delta-decalactone | 705-86-2 |
| 4-vinylguaiacol | 7786-61-0 |
| Amyl alicylate | 2050-08-0 |
| Cyclohexyl formate | 4351-54-6 |
| Dimethylbenzylcarbinyl acetate | 151-05-3 |
| Geranyl propionate | 105-90-8 |
| Terpinyl acetate | 80-26-2 |
| isopropyl 3-methylbutanoate | 32665-23-9 |
| isopropyl 2-methylbutanoate | 6676-71-4 |
| 3-Hexenyl 3-methylbutanoate | 10032-11-8 |
| Isoamyl 2-methylbutyrate | 27625-35-0 |
| 3-Octyl acetate | 4864-61-3 |
| Benzyl isobutyrate | 103-28-6 |
| Cis-3-hexenyl butyrate | 16491-36-4 |
| Cis-3-hexenyl lactate | 61931-81-5 |
| Citronellyl butyrate | 141-16-2 |
| Citronellyl propionate | 141-14-0 |
| Isoamyl hexanoate | 2198-61-0 |
| 1,3,5-Undecatriene | 16356-11-9 |
| 1-Benzyloxy-2-methoxy-4- | 120-11-6 |
| propenyl benzene | |
| 1-Octen-3-yl acetate | 198242 |
| 2-Acetyl-3-ethyl pyrazine | 32974-92-8 |
| 2-Isopropyl-4-methyl thiazole | 15679-13-7 |
| 2-Methyl-2-pentenoic acid | 3142-72-1 |
| 2-sec-butyl thiazole | 18277-27-5 |
| 4,5-Dimethyl thiazole | 3581-91-7 |
| 4-(2,6,6-Trimethyl-2-cyclohexen- | 31499-72-6 |
| 1-yl)butan-2-one | |
| 4-(2,6,6-Trimethyl cyclohexa- | 23696-85-7 |
| 1,3-dienyl)but-2-en-4-one | |
| Acetaldehyde phenethyl propyl | 7493-57-4 |
| acetal | |
| Acetaldehyde ethyl cis-3- | 28069-74-1 |
| hexenyl acetal | |
| Acetone propylene glycol acetal | 1193-11-9 |
| Acetyl isoeugenol | 93-29-8 |
| 2-Acetyl-5-methyl furan | 1193-79-9 |
| Allyl cyclohexylbutyrate | 7493-65-4 |
| Alpha,alpha- | 10094-34-5 |
| dimethylphenethylbutyrate | |
| Alpha,alpha-dimethyl phenethyl | 10058-43-2 |
| formate | |
| Alpha,beta-santalol | 11031-45-1 |
| Alpha-amyl cinnamaldehyde | 91-87-2 |
| dimethyl acetal | |
| Alpha-fenchyl acetate | 13851-11-1 |
| Alpha-furfuryl pentanoate | 36701-01-6 |
| Alpha-ionol | 25312-34-9 |
| 6-Methyl-alpha-ionone | 79-69-6 |
| Alpha-methyl-p- | 103-95-7 |
| isopropylphenylpropanaldehyde | |
| Alpha-n-amyl-beta-phenylacryl | 7493-78-9 |
| acetate | |
| Alpha-piperitone | 6091-50-5 |
| Alpha-n-amyl-beta-phenyl acryl | 7493-80-3 |
| isovalerate | |
| 6-Amyl-alpha-pyrone | 27593-23-3 |
| Anisyl formate | 122-91-8 |
| Benzylcarbinyl 2-methyl butyrate | 24817-51-4 |
| Benzylcarbinyl 3-phenyl | 103-53-7 |
| propenoate | |
| Benzylcarbinyl alpha-toluate | 102-20-5 |
| Benzylcarbinyl butyrate | 103-52-6 |
| Benzylcarbinyl caproate | 6290-37-5 |
| Benzylcarbinyl formate | 104-62-1 |
| Benzylcarbinyl isobutyrate | 103-48-0 |
| Benzylcarbinyl salicylate | 87-22-9 |
| Benzylcarbinyl tiglate | 55719-85-2 |
| Benzyl dipropyl ketone | 7492-37-7 |
| Benzyl tiglate | 37526-88-8 |
| Beta-homocyclocitral | 472-66-2 |
| Beta-ionol | 22029-76-1 |
| 3-Phenylpropyl propanoate | 122-74-7 |
| Bois de rose oxide | 7392-19-0 |
| Butyl 2-methyl butyrate | 15706-73-7 |
| Butyl cinnamate | 538-65-8 |
| ortho-sec-Butyl cyclohexanone | 14765-30-1 |
| isobutyl cis-2-methyl-2- | 7779-81-9 |
| butenoate | |
| 5-n-Butyl-delta-valerolactone | 3301-94-8 |
| Campholenic aldehyde | 4501-58-0 |
| Cedran-8-yl acetate | 77-54-3 |
| Cinnamyl isovalerate | 140-27-2 |
| Cis-3-hexenyl benzoate | 25152-85-6 |
| Cis-3-hexenyl caproate | 31501-11-8 |
| Cis-3-hexenyl formate | 33467-73-1 |
| Cis-3-hexenyl isobutyrate | 41519-23-7 |
| Cis-3-hexenyl phenylacetate | 42436-07-7 |
| Cis-3-hexenyl propionate | 33467-74-2 |
| Cis-3-hexenyl tiglate | 67883-79-8 |
| Cis-3-hexenyl valerate | 35852-46-1 |
| cis-4-Hepten-1-ol | 6191-71-5 |
| Cis-5-octen-1-ol | 64275-73-6 |
| Citral dimethyl acetal | 7549-37-3 |
| Citronellyl isobutyrate | 97-89-2 |
| Citronellyl isovalerate | 68922-10-1 |
| Citronellyl valerate | 7540-53-6 |
| Citroxide | 7416-35-5 |
| Cocal | 21834-92-4 |
| p-Cresyl alpha-toluate | 101-94-0 |
| p-Cresyl isovalerate | 55066-56-3 |
| Dehydro-beta-cyclocitral | 116-26-7 |
| 8,8-Diethoxy-2,6-dimethyl-2- | 7779-94-4 |
| octanol | |
| 5,7-Dihydro-2-methyl thieno(3,4- | 36267-71-7 |
| d)pyrimidine | |
| 2,5-Dihydro-4,5-dimethyl-2-(2- | 65894-83-9 |
| methyl propyl)thiazole | |
| Dihydrojasmone | 1128-08-1 |
| Dihydroxyacetophenone | 28631-86-9 |
| 1,1-Dimethoxy-3,7-dimethyl-7- | 141-92-4 |
| octanol | |
| 3,7-Dimethyl-1,6-octadien-3-yl | 126-64-7 |
| benzoate | |
| 3,7-Dimethyl-1,6-octadien-3-yl | 78-36-4 |
| butyrate | |
| 3,7-Dimethyl-1,6-octadien-3-yl | 78-35-3 |
| isobutyrate | |
| 3,7-Dimethyl-1,6-octadien-3-yl | 144-39-8 |
| propanoate | |
| cis-3,7-Dimethyl-2,6-octadien-1- | 2345-24-6 |
| yl 2-methyl propanoate | |
| 2,4-Dimethyl-3-cyclohexene-1- | 68039-49-6 |
| carboxaldehyde | |
| 2,6-Dimethyl-5-hepten-1-al | 106-72-9 |
| trans,cis-2,6-Dodecadien-1-al | 21662-13-5 |
| Eglantal | 26643-91-4 |
| Ethyl E-2-bexenoate | 27829-72-7 |
| Ethyl tiglate | 5837-78-5 |
| Ethyl trans-4-decenoate | 76649-16-6 |
| 5-Ethyl-4-hydroxy-2-methyl- | 27538-09-6 |
| 3[2H]furanone | |
| 2-Ethyl-4-methyl thiazole | 15679-12-6 |
| 2,6,10-Trimethyl-2,6,10- | 762-29-8 |
| pentadecatrien-14-one | |
| Guaiacyl phenyl acetate | 4112-89-4 |
| 3-Hepten-2-one | 1119-44-4 |
| trans-2-Hexen-1-ol | 2305-21-7 |
| Trans-2-hexenyl butyrate | 53398-83-7 |
| Hexyl phenylacetate | 5421-17-0 |
| Hexyl propionate | 2445-76-3 |
| Hydroxycitronellol | 107-74-4 |
| Isobutyl 2-butenoate | 589-66-2 |
| Isobutyl salicylate | 87-19-4 |
| Isodihydro lavandulal | 35158-25-9 |
| Isoeugenyl phenyl acetate | 120-24-1 |
| Isopropyl alpha-methylcrotonate | 1733-25-1 |
| p-Menth-1-en-8-yl propionate | 80-27-3 |
| Menthalactone | 13341-72-5 |
| 3-Methoxy-p-cymene | 1076-56-8 |
| Methyl 4-methyl pentanoate | 2412-80-8 |
| alpha-Methyl benzyl formate | 7775-38-4 |
| 2-Methylbutyl 2-methylbutanoate | 2445-78-5 |
| Methyl c-2-octenoate | 2396-85-2 |
| p-Methyl hydratropaldehyde | 99-72-9 |
| 3-(5-Methyl-2-furyl)butanal | 31704-80-0 |
| Nerol oxide | 1786-08-9 |
| trans,cis-2,6-Nonadien-1-ol | 7786-44-9 |
| trans-2-Octen-1-yl acetate | 3913-80-2 |
| 3-Octen-2-one | 1669-44-9 |
| 2-Phenyl-2-butenal | 4411-89-6 |
| 2-Propionylthiazole | 43039-98-1 |
| 1-Hydroxy-2-butanone | 5077-67-8 |
| 2-Butanone, 3-hydroxy-, (+−)- | 52217-02-4 |
| Thiazole, 2,5-dimethyl- | 4175-66-0 |
| Butanethioic acid, S-methyl | 2432-51-1 |
| ester | |
| 2,4-Hexadienoic acid, methyl | 689-89-4 |
| ester, (E,E)- | |
| Benzeneacetaldehyde, 4- | 104-09-6 |
| methyl- | |
| Bicyclo[4.1.0]hept-3-ene, 3,7,7- | 498-15-7 |
| trimethyl-, (1S)- | |
| Ethyl 3-hexenoate | 2396-83-0 |
| 1H-Pyrrole, 1-(2-furanylmethyl)- | 1438-94-4 |
| 6-Octenal, 3,7-dimethyl-, (R)- | 2385-77-5 |
| Ethanethioic acid, S-(2- | 13678-68-7 |
| furanylmethyl) ester | |
| 6-Octen-1-ol, 3,7-dimethyl-, (R)- | 1117-61-9 |
| 6-Octen-1-ol, 3,7-dimethyl-, (S)- | 7540-51-4 |
| DL-Tetrohydrofurfuryl propionate | 637-65-0 |
| Benzenepentanol | 10521-91-2 |
| Cyclohexaneethanol, acetate | 21722-83-8 |
| Benzyl isobutyl ketone | 5349-62-2 |
| Butanoic acid, 3-oxo-, | 5396-89-4 |
| phenylmethyl ester | |
| 1,2-Ethanediamine, N,N′- | 140-28-3 |
| bis(phenylmethyl)- | |
| 2-Ethyl-3-hydroxy-4-pyrone | 1110651 |
| Dicyclohexyl disulfide | 2550-40-5 |
| Tetrahydrofurfuryl butyrate | 2217-33-6 |
| Thujone | 546-80-5 |
| Benzyl alcohol, alpha-methyl-, | 3460-44-4 |
| butyrate | |
| Citronellyl tiglate | 24717-85-9 |
| Lacitol | 585-86-4 |
| Nonivamide | 244-46-4 |
| 2-Acetoxy-3-butanone | 4906-24-5 |
| 3-Acetyl-2,5-dimethylthiophene | 230378 |
| 3-Acetyl-2-5dimethylfuran | 10599-70-9 |
| 4-Acetyl-6-t-butyl-1,1- | 13171-00-1 |
| dimethylindan | |
| Allyl 2-furoate | 4208-49-5 |
| Allyl sorbate | 7493-75-6 |
| Allyl thiopropionate | 41820-22-8 |
| Allyl tiglate | 7493-71-2 |
| Amylcyclohexyl acetate | 67874-72-0 |
| Benzaldehyde glyceryl acetal | 1319-88-6 |
| Benzaldehyde propylene glycol | 2568-25-4 |
| acetal | |
| Bornyl isovalerate | 76-50-6 |
| 1,3-Butanedithiol | 24330-52-7 |
| 2,3-Butanedithiol | 4532-64-3 |
| Butyl cinnamic aldehyde | 7492-44-6 |
| Cinnamyl benzoate | 5320-75-2 |
| Citral ethylene glycol acetal | 66408-78-4 |
| Citronellyloxyacetaldehyde | 7492-67-3 |
| Citrionellyl phenylacetate | 139-70-8 |
| Cyclohexyl isovalerate | 7774-44-9 |
| Decalactone | 5579-78-2 |
| 2,5-Dimethyl-4-methoxy-3(2H)- | 4077-47-8 |
| furanone | |
| 6,10-Dimethyl-9-undecen-2-one | 4433-36-7 |
| 2-Ethoxythiazole | 15679-19-3 |
| Ethyl 2-mercaptopropionate | 19788-49-9 |
| Ethyl 2-methyl-4-pentenoate | 53399-81-8 |
| Ethyl 3-(2-furyl)propanoate | 94278-27-0 |
| Ethyl cyclohexanepropionate | 10094-36-7 |
| Ethyl (p-tolyloxy)acetate | 67028-40-4 |
| 3-Ethyl-2-hydroxy-2- | 21835-01-8 |
| cyclopenten-1-one | |
| Ethylene brassylate | 105-95-3 |
| 2-Ethylfenchol | 18368-91-7 |
| Furfuryl 3-methylbutanoate | 13678-60-9 |
| Furfuryl butyrate | 623-21-2 |
| Furfuryl isopropyl sulfide | 1883-78-9 |
| Furfuryl methyl sulfide | 1438-91-1 |
| Furfuryl propionate | 623-19-8 |
| Furfuryl thiopropionate | 59020-85-8 |
| Geranyl acetoacetate | 10032-00-5 |
| Geranyl benzoate | 94-48-4 |
| Geranyl isovalerate | 109-20-6 |
| delta-Hexalactone | 823-22-3 |
| trans-3-Hexenal | 69112-21-6 |
| cis-3-Hexenyl anthranilate | 65405-76-7 |
| trans-2-Hexenyl propionate | 53398-80-4 |
| 5-(cis-3-Hexenyl) dihydro-5- | 70851-61-5 |
| methyl-2(3H)furanone | |
| Hexyl 2-formate | 39251-86-0 |
| Hexyl crotonate | 19089-92-0 |
| Hexyl formate | 629-33-4 |
| Isoamyl 3-(2-furyl)propionate | 7779-67-1 |
| Isoamyl pyruvate | 7779-72-8 |
| Isobutyl furylpropionate | 105-01-1 |
| Isohexenyl cyclohexenyl | 37677-14-8 |
| carboxaldehyde | |
| p-Isopropyl phenylacetaldehyde | 4395-92-0 |
| Linalyl cinnamate | 78-37-5 |
| Linalyl formate | 115-99-1 |
| Linalyl isovalerate | 1118-27-0 |
| Linalyl phenylacetate | 7143-69-3 |
| Maltol isobutryrate | 65416-14-0 |
| Methyl 2-methylpentanoate | 2177-77-7 |
| Methyl 3-hydroxyhexanoate | 21188-58-9 |
| Methyl 3-nonenoate | 13481-87-3 |
| Methyl furfuryl disulfide | 57500-00-2 |
| Methyl p-tert-butylphenylacetate | 3549-23-3 |
| 3-Methyl-1,2-cyclohexanedione | 3008-43-3 |
| alpha-Methylanisalacetone | 104-27-8 |
| 2-Methylbutyl isovalerate | 2445-77-4 |
| 4-Methylnonanoic acid | 45019-28-1 |
| 4-Methyloctanoic acid | 54947-74-9 |
| 2-Methyltetrahydrothiophen-3- | 13679-85-1 |
| one | |
| 3-(Methylthio)butanal | 16630-52-7 |
| 4-(Methylthio)butanol | 20582-85-8 |
| 4-Methylthio-2-butanone | 34047-39-7 |
| 4-Methylthio-4-methyl-2- | 23550-40-5 |
| pentanone | |
| Neryl butyrate | 999-40-6 |
| Neryl formate | 2142-94-1 |
| Neryl isovalerate | 3915-83-1 |
| Octahydrocoumarin | 4430-31-3 |
| Phenethyl 2-furoate | 7149-32-8 |
| 1-Phenyl-2-pentanol | 705-73-7 |
| Phenylacetaldehyde | 68345-22-2 |
| diisobutylacetal | |
| Phenylacetaldehyde glyceryl | 29895-73-6 |
| acetal | |
| 2-(3-Phenylpropyl)pyridine | 2110-18-1 |
| Propyl phenylacetate | 4606-15-9 |
| Pyrazineethanethiol | 35250-53-4 |
| Ethyl 2-methyl pentanoate | 39255-32-8 |
| Methyl 2,4-decadienoate | 4493-42-9 |
| alpha-Isomethyl ionone | 127-51-5 |
| 5-Methyl hexanoic acid | 628-46-6 |
| Ethyl 3-methyl pentanoate | 5870-68-8 |
| Ethyl 2-methyl-3,4- | 60523-21-9 |
| pentadienoate | |
| 3-Nonen-2-one | 14309-57-0 |
| 5-Methyl-3-hexen-2-one | 5166-53-0 |
| Maltol propionate | 68555-63-5 |
| 2-Methyl-3-(2-furyl) acrolein | 874-66-8 |
| Ethyl 3(2-furyl)propanoate | 10031-90-0 |
| 2-Phenyl-3-(2-furyl)-propenal | 57568-60-2 |
| 4-Methyl-2-pentyl-1,3-dioxolane | 1599-49-1 |
| 2-Ethyl-4,5-dimethyl oxazole | 53833-30-0 |
| Isobornyl isovalerate | 7779-73-9 |
| Theophylline-7-acetic acid | 652-37-9 |
| Ethyl trans-2-octenoate | 7367-82-0 |
| DL-Arginine | 7200-25-1 |
| Allyl Crotonate | 20474-93-5 |
| 2-Methoxystyrene | 612-15-7 |
| Magnesium Fumarate | 7704-71-4 |
| 2-Propionylpyrrole | 1073-26-3 |
| 2-methyl-1,3-dithiolane | 5616-51-3 |
| 2-ethyl-5-methyl pyrazine | 13360-64-0 |
| 2-methyl-3-(dimercaptomethyl)- | 65505-17-1 |
| furan | |
| Magnesium gluconate | 3632-91-5 |
| Manganese gluconate | 6485-39-8 |
| Erythritol | 149-32-6 |
| D-Arabinose | 28697-53-2 |
| D-Galactose | 59-23-4 |
| D-(+)-Mannose | 3458-28-4 |
| Sorbitol | 50-70-4 |
| Aspartame | 22839-47-0 |
| Cyclamic Acid | 100-88-9 |
| Dulcin | 150-69-6 |
| Glucose-1-phosphate | 29732-59-0 |
| Dipotassium Salt | |
| L-(+)-Arabinose | 87-72-9 |
| Fructose-6-Phosphate | 643-13-0 |
| D-Maltose Monohydrate | 6363-53-7 |
| Ribose | 24259-59-4 |
| Fructose 1,6-Diphosphate | 26177-85-5 |
| Disodium Salt | |
| Saccharin sodium, dihydrate | 6155-57-3 |
| 1,2-Benzisothiazol-3(2H)-one | 6485-34-3 |
| 1,1-dioxide, calcium salt | |
| 1,2-Benzisothiazolin-3-one | 10332-51-1 |
| 1,1-dioxide, potassium salt | |
| zeranol | 26538-44-3 |
| beta-D-fructopyranose | 7660-25-5 |
| D-fructose, 1,6-bisphosphate | 488-69-7 |
| Ribose 5-phosphate | 4300-28-1 |
| Arabinose | 147-81-9 |
| Saccharin, sodium salt hydrate | 82385-42-0 |
| Maltitol | 585-88-6 |
| D-Fructose 1-phosphate | 15978-08-2 |
| D-Sorbitol 6-phosphate | 108392-12- |
| alpha-D-Xylose | 31178-70-8 |
| Inositol 1-phosphate | 573-35-3 |

Table 3 sets forth the group comprising molecules believed at present to be suitable guests. It is contemplated that the guests set forth in the Table may be arranged in subgroups based upon molecular structure and/or physiological effect. Furthermore, the foregoing list is intended to provide a written description of any sublist that omits one or more guests.

TABLE 3

| Name | CAS # |
|---|---|
| Sodium Metabisulfite | 7681-57-4 |
| sodium hydrogen phosphate | 7558-79-4 |
| Sodium Phosphate Monobasic | 7558-80-7 |
| Sodium thiosulfate | 7772-98-71 |
| Orthoboric acid | 10043-35-3 |
| Diethanolamine | 111-42-2 |
| Benzaldehyde | 100-52-7 |
| Sorbic acid | 110-44-1 |
| L-(+) Tartaric Acid | 87-69-4 |
| D-mannnitol | 69-65-8 |
| Butyl paraben | 94-26-8 |
| Thymol | 89-83-8 |
| Methyl salicylate | 119-36-8 |
| Citric acid | 77-92-9 |
| Creatinine | 60-27-5 |
| Vitamin C | 50-81-7 |
| Benzoic Acid | 65-85-0 |
| Methyl 4-hydroxybenzoate | 99-76-3 |
| m-Cresol | 108-39-4 |
| p-Cresol | 106-44-5 |
| Aspirin | 50-78-2 |
| Phenol | 108-95-2 |
| Sucrose | 57-50-1 |
| Potassium citrate, monohydrate | 1534146 |
| Sodium acetate | 127-09-3 |
| Lactic acid | 50-21-5 |
| Propionic acid, sodium salt | 65-85 |
| Benzyl alcohol | 100-51-6 |
| Phenethyl alcohol | 60-12-8 |
| Cholesterol | 57-88-5 |
| D-Glucose | 50-99-7 |
| Sorbitol | 50-70-4 |
| Aspartame | 22839-47-0 |
| Saacharin | 81-07-2 |
| 2,6-Di-tert-Butyl-p-Cresol | 128-37-0 |
| 4-Chloro-3-methylphenol | 59-50-7 |
| glycerin | 56-81-5 |
| Propyl paraben | 94-13-3 |
| fumaric acid | 110-17-8 |
| dabco | 280-57-9 |
| p-Phenylenediamine | 106-50-3 |
| Anethole | 4180-23-8 |
| propyl gallate | 121-79-9 |
| L-monosodium glutamate | 142-47-2 |
| Butylated hydroxyanisole | 25013-16-5 |
| Cyclohexanol, 5-methyl1-2-(1- | 89-78-1 |
| methylethyl)-, (1alpha, 2beta, | |
| 5alpha)- | |
| Alpha-Thioglycerol | 96-27-5 |
| Sodium dehydroacetate | 4418-26-2 |
| Ethyl 4-hydroxybenzoate | 120-47-8 |
| Ethyl Vanillin | 121-32-4 |
| Triacetin | 102-76-1 |
| Potassium sorbate | 590-00-1 |
| Triethyl citrate | 77-93-0 |
| (S)-(+)-Arginine | 74-79-3 |
| Glycine | 56-40-6 |
| (S)-(−)_Histidine | 71-00-1 |
| (S)-(+)-Lysine | 56-87-1 |
| Quinone | 106-51-4 |
| Naphthalene, 2-ethoxy- | 93-18-5 |
| Methanesulfonic Acid | 75-75-2 |
| DL-Tartaric Acid | 133-37-9 |
| Cyclamic acid | 100-88-9 |
| (S)-(−)-Phenylalanine | 63-91-2 |
| (S)-(−)-Tyrosine | 60-18-4 |
| Carvone | 99-49-0 |
| Ethyl butynate | 105-54-4 |
| 6-Methyl-5-hepten-2-one | 110-93-0 |
| Ethyl acetoacetate | 141-97-9 |
| Methyl benzoate | 93-58-3 |
| Phenylacetic Acid | 103-82-2 |
| Adipic acid | 124-04-9 |
| Ethyl benzoate | 93-89-0 |
| Benzyl benzoate | 120-51-4 |
| Pyruvic acid | 127-17-3 |
| Succinic acid | 110-15-6 |
| Indole | 120-72-9 |
| Methyl anthranilate | 134-20-3 |
| Diethyl malonate | 105-53-3 |
| Niacin | 59-67-6 |
| Meso-inositol | 87-89-8 |
| 4-Aminobenzoic acid | 150-13-0 |
| Anisole | 100-66-3 |
| Urea | 57-13-6 |
| Pyrrolidine | 123-75-1 |
| Cyclopentanone | 120-92-3 |
| Acetic anhydride | 108-24-7 |
| Benzophenone | 119-61-9 |
| D-(−)-Fructose | 57-48-7 |
| D-(+)-Xylose | 58-86-6 |
| o-Methoxybenzoic Acid | 579-75-9 |
| linalool | 78-70-6 |
| ethyl isovalerate | 108-64-5 |
| 1,1′-Azobisformamide | 123-77-3 |
| 6-Methylcoumarin | 92-48-8 |
| acetoin | 513-86-0 |
| alpha-Phellandrene | 99-83-2 |
| Cymene | 99-87-6 |
| Dimethyl Succinate | 106-65-0 |
| p-Anisaldehyde | 123-11-5 |
| Phenyl ether | 101-84-8 |
| Tetrahydro-2-furanmethanol | 97-99-4 |
| Valeric Acid | 109-52-4 |
| 3,4-xylenol | 95-65-8 |
| 1,1-diethoxyethane | 105-57-7 |
| ethyl butyraldehyde | 97-96-1 |
| Ethyl crotonate | 623-70-1 |
| ethyl isobutyrate | 97-62-1 |
| methyl isovalerate | 556-24-1 |
| methyl propionate | 554-12-1 |
| methyl valeraldehyde | 123-15-9 |
| 4-(2,6,6-Trimethyl-2-cyclobexen- | 127-41-3 |
| 1-yl)-3-buten-2-one | |
| 4-(2,6,6-trimethyl-1- | 14901-07-6 |
| cyclohexen-1-yl)-3-buten-2-one | |
| Maleic acid | 110-16-7 |
| 3-Methylbutanoic acid | 503-74-2 |
| L-Glutamic Acid | 56-86-0 |
| D-limonene | 5989-27-5 |
| 1-Phenyl-1-propanol | 93-54-9 |
| 2-Hydroxyacetophenone | 118-93-4 |
| 2,4-Dihydroybenzoic Acid | 89-86-1 |
| 2-Phenyl-1-propanol | 1123-85-9 |
| 3-Phenylpropionic Acid | 501-52-0 |
| 4-Ethoxyphenol | 622-62-8 |
| Alpha-Terpineol | 98-55-5 |
| Benzaldehyde Dimethylacetal | 1125-88-8 |
| Benzyl Ether | 103-50-4 |
| Benzyl Formate | 104-57-4 |
| Benzyl Salicylate | 118-58-1 |
| Cinnamyl Alcohol | 104-54-1 |
| D-(+)-Glucono-1,5-lactone | 4253-68-3 |
| D-Isoascorbic Acid | 89-65-6 |
| 2,3-Naphtalenediol | 92-44-4 |
| Diethyl Succinate | 123-25-1 |
| Ethyl 2-Aminobenzoate | 87-25-2 |
| Ethyl Cinnamate | 103-36-6 |
| Ethyl Phenylacetate | 101-97-3 |
| Ethyl Salicylate | 118-61-6 |
| gamma-Valerolactone | 108-29-2 |
| Hydroquinone Dimethyl Ether | 150-78-7 |
| Isocaproic Acid | 646-07-01 |
| Isoeugenol | 97-54-1 |
| Isopropyl Benzoate | 939-48-0 |
| L-(+)-Isoleucine | 73-32-5 |
| L-Malic acid | 97-67-6 |
| L-2-Aminopropionic Acid | 56-41-7 |
| L-Carnitine | 541-15-1 |
| L-Glutamine | 56-85-9 |
| L-Hydroxyproline | 51-35-4 |
| L-Proline | 147-85-3 |
| L-Serine | 56-45-1 |
| L-Threonine | 72-19-5 |
| L-Valine | 72-18-4 |
| Phenoxyacetic Acid | 122-59-8 |
| Veratrole | 91-16-7 |
| 2-Ethylbutyric acid | 88-09-5 |
| 2-Methylpyrazine | 109-08-0 |
| o-methoxybenzaldehyde | 135-02-4 |
| L-Leucine | 61-90-5 |
| L-Asparagine | 70-47-3 |
| propiophenone | 93-55-0 |
| 5-isopropyl-2-methyl-phenol | 499-75-2 |
| Xylitol | 87-99-0 |
| ethyl 4-oxopentanoate | 539-88-8 |
| methyl cinnamate | 103-26-4 |
| cumic alcohol | 536-60-7 |
| methyl 2-naphthyl ketone | 93-08-3 |
| 1-methyl-4-(1-methylethyl)- | 99-85-4 |
| 1,4-Cyclobexadiene | |
| en-ethylene diamine | |
| Caffeine | 58-08-2 |
| 5-methylfurfural | 620-02-0 |
| furfuryl acetate | 623-17-6 |
| terpinen-4-ol | 10482-56-1 |
| phenylethanal | 122-78-1 |
| 4′-Methoxyacetophenone | 100-06-01 |
| D-Fenchone | 4695-62-9 |
| 1-Methoxy-4-methylbenzene | 104-93-8 |
| o-methylanisole | 578-58-5 |
| Acetylacetaldehyde dimethyl | 5436-21-5 |
| acetal | |
| p-methylacetophenone | 122-00-9 |
| Methyl phenylacetate | 101-41-7 |
| 4-Ethoxybenzaldehyde | 10031-82-0 |
| p-tolyl acetate | 140-39-6 |
| 2,6-Dimethoxyphenol | 91-10-1 |
| Methyl 2-methoxybenzoate | 606-45-1 |
| alpha-methicinnamaldehyde | 101-39-3 |
| 2-methoxycinnamaldehyde | 60125-24-8 |
| Potassium bicarbonate | 298-14-6 |
| piperonyl acetate | 326-61-4 |
| 2,3-hexanedione | 3848-24-6 |
| furfural acetone | 623-15-4 |
| trans beta-(2-furyl)acrolein | 623-30-3 |
| carveol | 99-48-9 |
| Methyl nicotinate | 93-60-7 |
| Ethyl benzoylacetate | 94-02-0 |
| Methyl 4-methoxybenzoate | 121-98-2 |
| Luvulinic acid | 123-76-2 |
| m-Dimethoxybenzene | 151-10-0 |
| 2-acetylpyridine | 1122-62-9 |
| tetramethyl-pyrazine | 1124-11-4 |
| 2,3-dimethyl-pyrazine | 5910-89-4 |
| trimethyl-pyrazine | 14667-55-1 |
| 2-ethyl-3-methyl-pyrazine | 15707-23-0 |
| 5-Methyl-3H-furan-2-one | 591-12-8 |
| 2-Methoxy-4-methylphenol | 93-51-6 |
| piperazine | 110-85-0 |
| 2-Methoxy-4-propylphenol | 2785-87-7 |
| Naphthalene, 2-(2- | 2173-57-1 |
| methylpropoxy)- | |
| 2-Acetyl-1-methylpyrrole | 932-16-1 |
| 3,3-Dimethylacrylic acid | 541-47-9 |
| Ethyl sorbate | 2396-84-1 |
| 4-(4-Hydroxyphenyl)-2-butanone | 5471-51-2 |
| 4-Methoxyphenylacetone | 122-84-9 |
| (−)-Myrtenal | 564-94-3 |
| 3-Phenylpropionaldehyde | 104-53-0 |
| 1-Phenylethyl propionate | 120-45-6 |
| 2-Methyltetrahydrofuran-3-one | 3188-00-9 |
| Cinnamyl acetate | 103-54-8 |
| Styrallyl acetate | 93-92-5 |
| Ethyl 4-methoxybenzoate | 94-30-4 |
| Benzyl propionate | 122-63-4 |
| Phenylpyruvate | 156-06-9 |
| furaneol | 3658-77-3 |
| methyl 2-methylbutanoate | 868-57-5 |
| Benzeneacetaldehyde, alpha- | 93-53-8 |
| methyl-Dimethyl anthranilate | 85-91-6 |
| 1,1-Dimethoxy-2-phenylpropane | 90-87-9 |
| 4-hexanolide | 695-06-7 |
| Dimethylbenzylcarbinyl acetate | 151-05-3 |
| Benzyl isobutyrate | 103-28-6 |
| Acetyl isoeugenol | 93-29-8 |
| 2-Acetyl-5-methyl furan | 1193-79-9 |
| Alpha-methyl-p- | 103-95-7 |
| isopropylphenylpropanaldehyde | 104-62-1 |
| Benzylcarbinyl formate | |
| p-Cresyl alpha-toluate | 101-94-0 |
| Potassium bisulfate | 7646-93-7 |
| Potassium carbonate | 584-08-7 |
| Potassium chloride | 7447-40-7 |
| Potassium hydroxide | 1310-58-3 |
| Ethyl tiglate | 5837-78-5 |
| Nerol oxide | 1786-08-9 |
| DL-Tetrohydrofurfuryl propionate | 637-65-0 |
| Benzaldehyde propylene glycol | 2568-25-4 |
| acetal | |
| 2-Methyl-3-(2-furyl) acrolein | 874-66-8 |
| vanillin | 121-35-5 |
| Cholic acid | 81-25-4 |
| R-Carvone | 6485-40-1 |
| Potassium nitrate | 7757-79-1 |
| Potassium permanganate | 7722-64-7 |
| Potassium persulfate | 7727-21-1 |
| Potassium phosphate, dibasic | 2139900 |
| potassium Phosphate | 7778-77-0 |
| Monobasic | |
| Potassium sulfate | 7778-80-5 |
| Sodium bicarbonate | 144-55-8 |
| Sodium bisulfite | 7631-90-5 |
| Sodium carbonate | 497-19-8 |
| Sodium chloride | 7647-14-5 |
| Sodium dithionite | 7775-14-6 |
| Sodium hydroxide | 1310-73-2 |
| Sodium nitrite | 7632-00-0 |
| Sodium Pyrophosphate | 7722-88-5 |
| Sodium sulfate | 7757-82-6 |
| Sodium sulfite | 7757-83-7 |
| Sodium thiocyanate | 540-72-7 |
| Calcium Carbonate | 471-34-1 |
| Calcium chloride | 10043-52-4 |
| Calcium gluconate | 299-28-5 |
| Calcium hydroxide | 1305-62-0 |
| Calcium phosphate, dibasic | 7757-93-9 |
| Calcium sulfate | 7778-18-9 |
| N-methyl-D-glucamine | 6284-40-8 |
| Calcium oxide | 1305-78-8 |
| Calcium Phosphate Monobasic | 7758-23-8 |
| Magnesium chloride | 7791-18-6 |
| hexahydrate | |
| Magnesium sulfate | 7487-88-9 |
| Magnesium Sulfate | 10034-99-8 |
| Heptahydrate | |
| Aluminum chloride hexahydrate | 7784-13-6 |
| aluminum nitrate nonahydrate | 7784-27-2 |
| Aluminum potassium sulfate, | 7784-24-9 |
| dodecabydrate | |
| Aluminum sulfate | 7784-31-8 |
| octadecahydrate | |
| (S)-(−)-Cysteine | 52-90-4 |
| p-Toleunesulfonic Acid | 104-15-4 |
| Potassium bitartrate | 868-14-4 |
| DL-aspartic acid | 617-45-8 |
| p-Dimethylaminobenzaldehyde | 100-10-7 |
| Sodium salicylate | 54-21-7 |
| Benzoin | 119-53-9 |
| Sodium dodecyl sulfate | 151-21-3 |
| L-Menthol | 2216-51-5 |
| Tiron | 149-45-1 |
| Riboflavin | 83-88-5 |
| Sodium Acelate Trihydrate | 6131-90-4 |
| Disodium Succinate | 6106-21-4 |
| Hexahydrate | |
| Disodium | 6381-92-6 |
| ethylenediaminetetraacetate | |
| dihydrate | |
| sodium citrate, dihydrate | 1545801 |
| Sodium potassium tartrate, | 6381-59-5 |
| tetrahydrate | |
| L-(+)-Arginine | 1119-34-2 |
| monohydrochloride | |
| Ethylenediamine | 333-18-6 |
| dihydrochloride | |
| Sodium formate | 141-53-7 |
| Sodium acetate | 127-09-3 |
| Potassium acetate | 127-08-2 |
| Ammonium citrate | 3012-65-5 |
| Ammonium bicarbonate | 1066-33-7 |
| Ammonium chloride | 12125-02-9 |
| Ammonium nitrate | 6484-52-2 |
| Ammonium persulfate | 7727-54-0 |
| Ammonium sulfate | 7783-20-2 |
| Zinc chloride | 7646-85-7 |
| Sulfuric acid, zinc salt | 7446-20-0 |
| (1:1), heptahydrate | |
| Sodium Tripolyphosphate | 7758-29-4 |
| ammonium henzoate | 1863-63-4 |
| ammonium bisulfite | 10192-30-0 |
| 1,5-Naphthalenedisulfonic Acid | 1655-29-4 |
| Disodium Salt | |
| 4-Hydroxybenzoic Acid | 99-96-7 |
| Diphenylacetic Acid | 117-34-0 |
| Glutaric Acid | 110-94-1 |
| L-(−)-Fucose | 2438-80-4 |
| L-Cysteine Hydrochloride | 52-89-1 |
| L-Histidine Hycrochloride | 1880304 |
| Monohydrate | |
| o-Toluic Acid | 118-90-1 |
| Pivalic Acid | 75-98-9 |
| Pyruvic Acid Sodium Salt | 113-24-6 |
| Potassium bromide | 2139626 |
| Sodium Dithionate Dihydrate | 7631-94-9 |
| Sodium Malonate | 141-95-7 |
| Trisodium Citrate | 68-04-2 |
| Potassium Sodium Tartrate | 304-59-6 |
| Potassium Citrate | 866-84-2 |
| D-Maltose Monohydrate | 6363-53-7 |
| Cyclohexaamylose | 10016-20-3 |
| Dodecyl sulfate, lithium salt | 2044-56-6 |
| Manganese chloride | 2145076 |
| methyl-urea | 598-50-5 |
| beta-Cyclodextrin | 7585-39-9 |
| Triphosphoric acid, | 13845-36-8 |
| pentapotassium salt | |
| Glycine ethyl ester | 623-33-6 |
| hydrochloride | |
| L-Histidine methyl ester | 7389-87-9 |
| dihydrochloride | |
| L-Leucine methyl ester | 7517-19-3 |
| hydrochloride | |
| D-Lysine hydrochloride | 7274-88-6 |
| 2-Naphthalenesulfonic acid | 532-02-5 |
| sodium salt | |
| calcium nitrate tetrahydrate | 13477-34-4 |
| Vitamin B1 | 59-43-8 |
| Zinc Acetate Dihydrate | 5970-45-6 |
| Potassium fluoride | 7789-23-3 |
| Potassium iodate | 2139718 |
| Potassium iodide | 7681-11-0 |
| Potassium thiocyanate | 333-20-0 |
| Sodium bromide | 7647-15-6 |
| Sodium flouride | 7681-49-4 |
| Sodium iodide | 7681-82-5 |
| Sodium nitrate | 7631-99-4 |
| Calcium acetate | 5743-26-0 |
| Trichioracetic acid | 76-03-9 |
| Ammonium acetate | 631-61-8 |
| Ammonium flouride | 12125-01-8 |
| DL-malic acid | 617-48-1 |
| t-Butyl Alcohol | 75-65-0 |
| beta-Alanine | 107-95-9 |
| (S)-(−)-Tryptophan | 73-22-3 |
| Malonic acid | 141-82-2 |
| Phenethylamine | 64-04-0 |
| Salicylylaldehyde | 90-02-8 |
| Sodium benzoate | 532-32-1 |
| Mandelic acid | 90-64-2 |
| Calcium pantothenate | 137-08-6 |
| Chloracetic Acid | 79-11-8 |
| Ethanol Amine | 141-43-5 |
| Salicylic acid | 69-72-7 |
| Saccharin sodium | 128-44-9 |
| Thiamine hydrochloride | 67-03-8 |
| 2,2′-Oxybisethanol | 111-46-6 |
| Resorcinol | 108-46-3 |
| 2-Amino-2-(hydroxymethyl)-1,3- | 77-86-1 |
| propanediol | |
| 2,5-Dimethylphenol | 95-87-4 |
| Ammonium Phosphate | 7722-76-1 |
| Monobasic | |
| 1,3-Butanediol | 107-88-0 |
| Glycolic Acid | 79-14-1 |
| Sodium gluconate | 527-07-1 |
| Terephthalic Acid | 100-21-0 |
| L-Ascorbic Acid Sodium Salt | 134-03-2 |
| 3-Acetyl-6-methyl-2,4- | 520-45-6 |
| pyrandione | |
| Calcium Acetate | 62-54-4 |
| Nicotinamide | 98-92-0 |
| 1-Hydroxy-2-napthoic Acid | 86-48-6 |
| 2-Isopropylphenol | 88-69-7 |
| 4-Aminosalicyclic Acid | 65-49-6 |
| Calcium Glycerophosphate | 27214-00-2 |
| Erythorbic Acid Sodium Salt | 7378-23-6 |
| Gluconic Acid Potassium Salt | 299-27-4 |
| Orotic Acid | 65-86-1 |
| p-Anise Alcohol | 105-13-5 |
| Acetic anhydride | 108-24-7 |
| Benzophenone | 119-61-9 |
| D-(−)-Fructose | 57-48-7 |
| D-(+)-Xylose | 58-86-6 |
| o-Methoxybenzoic Acid | 579-75-9 |
| linalool | 78-70-6 |
| ethyl isovalerate | 108-64-5 |
| 1,1′-Azobisformamide | 123-77-3 |
| 6-Methylcoumarin | 92-48-8 |
| acetoin | 513-86-0 |
| alpha-Phellandrene | 99-83-2 |
| Cymene | 99-87-6 |
| Dimethyl Succinate | 106-65-0 |
| p-Anisaldehyde | 123-11-5 |
| Phenyl ether | 101-84-8 |
| Tetxahydro-2-furanmethanol | 97-99-4 |
| Valeric Acid | 109-52-4 |
| 3,4-xylenol | 95-65-8 |
| 1,1-diethoxyethane | 105-57-7 |
| ethyl butyraldehyde | 97-96-1 |
| Ethyl crotonate | 623-70-1 |
| ethyl isobutyrate | 97-62-1 |
| methyl isovalerate | 556-24-1 |
| methyl propionate | 554-12-1 |
| methyl valeraldehyde | 123-15-9 |
| 4-(2,6,6-Trimethyl-2- | 127-41-3 |
| cyclohexen-1-yl)-3-buten-2-one | |
| 4-(2,6,6-trimethyl-1- | 14901-07-6 |
| cyclohexen-1-yl)-3-buten-2-one | |
| Maleic acid | 110-16-7 |
| 3-Methylbutanoic acid | 503-74-2 |
| L-Glutamic Acid | 56-86-0 |
| D-limonene | 5989-27-5 |
| 1-Phenyl-1-propanol | 93-54-9 |
| 2′-Hydroxyacetophenone | 118-93-4 |
| 2,4-Dihydroxybenzoic Acid | 89-86-1 |
| 2-Phenyl-1-propanol | 1123-85-9 |
| 3-Phenylpropionic Acid | 501-52-0 |
| 4-Ethoxyphenol | 622-62-8 |
| Alpha-Terpineol | 98-55-5 |
| Bcnzaldehyde Dimethylacetal | 1125-88-8 |
| Benzyl Ether | 103-50-4 |
| Benzyl Formate | 104-57-4 |
| Benzyl Salicylate | 118-58-1 |
| Cinnamyl Alcohol | 104-54-1 |
| D-(+)-Glucono-1,5-lactone | 4253-68-3 |
| D-Isoascorbic Acid | 89-65-6 |
| 2,3-Naphthalenediol | 92-44-4 |
| Diethyl Succinate | 123-25-1 |
| Ethyl 2-Aminobenzoate | 87-25-2 |
| Ethyl Cinnamate | 103-36-6 |
| Ethyl Phenylacetate | 101-97-3 |
| Ethyl Salicylate | 118-61-6 |
| gamma-Valenolactone | 108-29-2 |
| Hydroquinone Dimethyl Ether | 150-78-7 |
| Isocaproic Acid | 646-07-1 |
| Isoeugenol | 97-54-1 |
| Isopropyl Benzoate | 939-48-0 |
| L-(+)-Isoleucine | 73-32-5 |
| L-Malic acid | 97-67-6 |
| L-2-Aminopropionic Acid | 56-41-7 |
| L-Carnitine | 541-15-1 |
| L-Glutamine | 56-85-9 |
| L-Hydroxyproline | 51-35-4 |
| L-Proline | 147-85-3 |
| L-Serine | 56-45-1 |
| L-Threonine | 72-19-5 |
| L-Valine | 72-18-4 |
| Phenozyacetic Acid | 122-59-8 |
| Veratrole | 91-16-7 |
| 2-Ethylbutyric acid | 88-09-5 |
| 2-Methylpyrazine | 109-08-0 |
| o-methoxybenzaldehyde | 135-02-4 |
| L-Leucine | 61-90-5 |
| L-Asparagine | 70-47-3 |
| propiophenone | 93-55-0 |
| 5-isopropyl-2-methyl-phenol | 499-75-2 |
| Xylitol | 87-99-0 |
| ethyl 4-oxopentanoate | 539-88-8 |
| methyl cinnamate | 103-26-4 |
| cumic alcohol | 536-60-7 |
| methyl 2-naphthyl ketone | 93-08-3 |
| 1-methyl-4-(1-methylethyl)- | 99-85-4 |
| 1,4-Cyclohexadiene | |
| en-ethylene diamine | |
| Caffeine | 58-08-2 |
| 5-methylfurfural | 620-02-0 |
| furfuryl acetate | 623-17-6 |
| terpinen-4-ol | 10482-56-1 |
| phenylethanal | 122-78-1 |
| 4′-Methoxyacetophenone | 100-06-1 |
| D-Fenchone | 4695-62-9 |
| 1-Methoxy-4-methylbenzene | 104-93-8 |
| o-methylanisole | 578-58-5 |
| Acetylacetaldehyde dimethyl | 5436-21-5 |
| acetal | |
| p-methylacetophenone | 122-00-9 |
| Methyl phenylacetate | 101-41-7 |
| 4-Ethoxybenzaldehydc | 10031-82-0 |
| p-tolyl acetate | 140-39-6 |
| 2,6-Dimethoxyphenol | 91-10-1 |
| Methyl 2-methoxybenzoate | 606-45-1 |
| alpha-methylcinnamaldehyde | 101-39-3 |
| 2-methoxycinnamaldehyde | 60125-24-8 |
| Potassium bicarbonate | 298-14-6 |
| piperonyl acetate | 326-61-4 |
| 2,3-hexanedione | 3848-24-6 |
| furfural acetone | 623-15-4 |
| trans beta-(2-furyl)acrolein | 623-30-3 |
| carveol | 99-48-9 |
| Methyl nicotinate | 93-60-7 |
| Ethyl benzoylacetate | 94-02-0 |
| Methyl 4-methoxybenzoate | 121-98-2 |
| Levulinic acid | 123-76-2 |
| m-Dimethoxybenzene | 151-10-0 |
| 2-acetylpyridine | 1122-62-9 |
| tetramethyl-pyrazine | 1124-11-4 |
| 2,3-dimethyl-pyzazine | 5910-89-4 |
| trimethyl-pyrazine | 14667-55-1 |
| 2-ethyl-3-methyl-pyrazine | 15707-23-0 |
| 5-Methyl-3H-furan-2-one | 591-12-8 |
| 2-Methoxy-4-methylphenol | 93-51-6 |
| piperazine | 110-85-0 |
| 2-Methoxy-4-propylphenol | 2785-87-7 |
| Naphthalene,2-(2- | 2173-57-1 |
| methylpropoxy)- | |
| 2-Acetyl-1-methylpyrrole | 932-16-1 |
| 3,3-Dimethylacrylic acid | 541-47-9 |
| Ethyl sorbate | 2396-84-1 |
| 4-(4-Hydroxyphenyl)-2-butanone | 5471-51-2 |
| 4-Methoxyphenylacetone | 122-84-9 |
| (−)-Myrtenal | 564-94-3 |
| 3-Phenylpropionaldehyde | 104-53-0 |
| 1-Phenylethyl propionate | 120-45-6 |
| 2-Methyltetrahydrofuran-3-one | 3188-00-9 |
| Cinnamyl acetate | 103-54-8 |
| Styrallyl acetate | 93-92-5 |
| Ethyl 4-methoxybenzoate | 94-30-4 |
| Benzyl propionate | 122-63-4 |
| Phenylpyruvate | 156-06-9 |
| furaneol | 3658-77-3 |
| methyl 2-methylbutanoate | 868-57-5 |
| Benzeneacetaldehyde, alpha- | 93-53-8 |
| methyl- | |
| Dimethyl anthranilate | 85-91-6 |
| 1,1-Dimethoxy-2-phenylpropane | 90-87-9 |
| 4-hexanolide | 695-06-7 |
| Dimethylbenzylcarbinyl acetate | 151-05-3 |
| Potassium Benzoate | 582-25-2 |
| Taurine | 107-35-7 |
| Thiamine Nitrate | 532-43-4 |
| 3,3,5-Trimethyl-1-cyclohexanol | 116-02-9 |
| tert-Butylhydroquinone | 1948-33-0 |
| Sulfosalicyclic acid | 97-05-2 |
| Gallic acid | 149-91-7 |
| L-borneol | 464-45-9 |
| Isoborneol | 124-76-5 |
| 2,5-Dihydroxybenzoic acid, | 490-79-9 |
| Gentisic acid | |
| 5-hydroxy-6-methyl-3,4- | 65-23-6 |
| pyridimedimethanol | |
| Naphthalene-2-sulfonic acid | 120-18-3 |
| Ethanesulfonic acid, 2-hydroxy-, | 1562-00-1 |
| monosodium salt | |
| Panoic acid | 130-85-8 |
| 2,4-Dimethylphenol | 105-67-9 |
| 3,5-Dihydroxyacetophenone | 51863-60-6 |
| Eugenol | 97-53-0 |
| a-Butyric Acid | 107-92-6 |
| Hydroquinone | 123-31-9 |
| Propionic Acid | 79-09-4 |
| meta-Phenylanediamine | 108-45-2 |
| Oxalic Acid | 144-62-7 |
| n-Hexanoic Acid | 142-62-1 |
| 2-Furancarboxylic Acid | 88-14-2 |
| 4′-Nitroacetanilide | 104-04-1 |
| D-(−)-Tartaric Acid | 147-71-7 |
| p-Acetamidobenzoic Acid | 556-08-1 |
| Galactaric acid | 526-99-8 |
| D-glucoronate | 1700908 |
| Lactobionic acid | 96-82-2 |
| p-Formylacetanilide | 122-85-0 |
| 2-Mercaptobenzoic acid | 147-93-3 |
| Propanioc acid, 2-hydroxy-, | 28305-25-1 |
| calcium salt (2:1), (S)- | |
| D(+)-10-Camphorsulfonic acid | 3144-16-9 |
| 3-Cyclopentylpropionic acid | 140-77-2 |
| 1R-(−)-Camphorsulfonic acid | 35963-20-3 |
| DL-Lysine | 70-54-2 |
| Cinnamic acid | 621-82-9 |
| Triethanolamine | 102-71-6 |
| Acetic Acid | 64-19-7 |
| Dichloroacetic Acid | 79-43-6 |
| Diethylamine | 109-89-7 |
| Diethylamineothanol | 100-37-8 |
| N-(2-Hydroxyethyl)Morpholine | 622-40-2 |
| Octanoic Acid | 124-07-2 |
| isobutyric acid | 79-31-2 |
| Anisic Acid | 100-09-4 |
| Betaine | 107-43-7 |
| Enanthoic Acid | 111-14-8 |
| Hippuric Acid | 495-69-2 |
| Tiglic Acid | 80-59-1 |
| Cyclohexanecarboxylic acid | 98-89-5 |
| m-Methoxybenzoic acid | 586-38-9 |
| D-(+)-Camphoric acid | 124-83-4 |
| N-(2-Hydroxyethyl)pyrrolidine | 2955-88-6 |
| Sodium Metabisulfite | 7681-57-4 |
| sodium hydrogen phosphate | 7558-79-4 |
| Sodium Phosphate Monobasic | 7558-80-7 |
| Sodium thiosulfate | 7772-98-71 |
| Orthoboric acid | 10043-35-3 |
| Diethanolamine | 111-42-2 |
| Benzaldehyde | 100-52-7 |
| Sorbic acid | 110-44-1 |
| L-(+)-Tartaric Acid | 87-69-4 |
| D-mannitol | 69-65-8 |
| Butyl paraben | 94-26-8 |
| Thymol | 89-83-8 |
| Methyl salicylate | 119-36-8 |
| Citric acid | 77-92-9 |
| Creatinine | 60-27-5 |
| Vitamin C | 50-81-7 |
| Benzoic Acid | 65-85-0 |
| Methyl 4-hydroxybenzoate | 99-76-3 |
| m-Cresol | 108-39-4 |
| p-Cresol | 106-44-5 |
| Aspirin | 50-78-2 |
| Phenol | 108-95-2 |
| Sucrose | 57-50-1 |
| Potassium citrate, monohydrate | 1534146 |
| Sodium acetate | 127-09-3 |
| Lactic acid | 50-21-5 |
| Propionic acid, sodium salt | 65-85 |
| Benzyl alcohol | 100-51-6 |
| Phenethyl alcohol | 60-12-8 |
| Cholesterol | 57-88-5 |
| D-Glucosc | 50-99-7 |
| Sorbitol | 50-70-4 |
| Aspartame | 22839-47-0 |
| Saccharin | 81-07-2 |
| 2,6-Di-tert-Butyl-p-Crcsol | 128-37-0 |
| 4-Chloro-3-mcthylphenol | 59-50-7 |
| glycerin | 56-81-5 |
| Propyl paraben | 94-13-3 |
| fumaric acid | 110-17-8 |
| dabco | 280-57-9 |
| p-Phenylenediamine | 106-50-3 |
| Ancthole | 4180-23-8 |
| propyl gallate | 121-79-9 |
| L-monosodium glutamate | 142-47-2 |
| Butylated hydroxyanisole | 25013-16-5 |
| Cyclohexanol, 5-mcthyl-2-(1- | 89-78-1 |
| methylethyl)-, | |
| (1alpha,2beta,5alpha)- | |
| alpha-Thioglycerol | 96-27-5 |
| Sodium dehydroacetate | 4418-26-2 |
| Ethyl 4-hydroxybenzoate | 120-47-8 |
| Ethyl Vanillin | 121-32-4 |
| Triacetin | 102-76-1 |
| Potassium sorbate | 590-00-1 |
| Triethyl citrate | 77-93-0 |
| (S)-(+)-Arginine | 74-79-3 |
| Glycine | 56-40-6 |
| (S)-(−)-Histidine | 71-00-1 |
| (S)-(+)-Lysine | 56-87-1 |
| Quinone | 106-51-4 |
| Naphthalene, 2-ethoxy- | 93-18-5 |
| Methanesulfonic Acid | 75-75-2 |
| DL-Tartaric Acid | 133-37-9 |
| Cyclamic acid | 100-88-9 |
| (S)-(−)-Phenylalanine | 63-91-2 |
| (S)-(−)-Tyrosine | 60-18-4 |
| Carvone | 99-49-0 |
| Ethyl butyrate | 105-54-4 |
| 6-Methyl-5-hepten-2-one | 110-93-0 |
| Ethyl acetoacetate | 141-97-9 |
| Methyl benzoate | 93-58-3 |
| Phenylacetic Acid | 103-82-2 |
| Adipic acid | 124-04-9 |
| Ethyl benzoate | 93-89-0 |
| Benzyl benzoate | 120-51-4 |
| Pyruvic acid | 127-17-3 |
| Succinic acid | 110-15-6 |
| Indole | 120-72-9 |
| Methyl anthranilate | 134-20-3 |
| Diethyl malonate | 105-53-3 |
| Niacin | 59-67-6 |
| Meso-inositol | 87-89-8 |
| 4-Aminobenzoic acid | 150-13-0 |
| Anisole | 100-66-3 |
| Urea | 57-13-6 |
| Pyriolidinc | 123-75-1 |
| Cyclopentanone | 120-92-3 |
| Benzyl isobutyrate | 103-28-6 |
| Acetyl isoeugenol | 93-29-8 |
| 2-Acetyl-5-methyl furan | 1193-79-9 |
| Alpha-methyl-p | 103-95-7 |
| isopropylphenylpropanaldehydc | |
| Bcnzylcarbinyl formate | 104-62-1 |
| p-Cresyl alpha-toluate | 101-94-0 |
| Potassium bisulfate | 7646-93-7 |
| Potassium carbonate | 584-08-7 |
| Potassium chloride | 7447-40-7 |
| Potassium hydroxide | 1310-58-3 |
| Ethyl tiglate | 5837-78-5 |
| Nerol oxide | 1786-08-9 |
| DL-Tetrohydrofurfuryl | 637-65-0 |
| propionate | |
| Bcnzaldehyde propylene glycol | 2568-25-4 |
| acetal | |
| 2-Methyl-3-(2-furyl) acrolein | 874-66-8 |
| vanillin | 121-33-5 |
| Cholic acid | 81-25-4 |
| R-Carvone | 6485-40-1 |
| Potassium nitrate | 7757-79-1 |
| Potassium permanganate | 7722-64-7 |
| Potassium persulfate | 7727-21-1 |
| Potassium phosphate, dibasic | 2139900 |
| Potassium Phosphate | 7778-77-0 |
| Monobasic | |
| Potassium sulfate | 7778-80-5 |
| Sodium bicarbonate | 144-55-8 |
| Sodium bisulfite | 7631-90-5 |
| Sodium carbonate | 497-19-8 |
| Sodium chloride | 7647-14-5 |
| Sodium dithionite | 7775-14-6 |
| Sodium hydroxide | 1310-73-2 |
| Sodium nitrite | 7632-00-0 |
| Sodium Pyrophosphate | 7722-88-5 |
| Sodium sulfate | 7757-82-6 |
| Sodium sulfite | 7757-83-7 |
| Sodium thiocyanate | 540-72-7 |
| Calcium Carbonate | 471-34-1 |
| Calcium chloride | 10043-52-4 |
| Calcium gluconatc | 299-28-5 |
| Calcium hydroxide | 1305-62-0 |
| Calcium phosphate, dibasic | 7757-93-9 |
| Calcium sulfate | 7778-18-9 |
| N-Methyl-D-glucamine | 6284-40-8 |
| Calcium oxide | 1305-78-8 |
| Calcium Phosphate Monobasic | 7758-23-8 |
| Magnesium chloride | 7791-18-6 |
| hexahydratc | |
| Magnesium sulfate | 7487-88-9 |
| Magnesium Sulfate | 10034-99-8 |
| Heptahydrate | |
| Aluminum chloride hexahydrate | 7784-13-6 |
| aluminum nitrate nonahydrate | 7784-27-2 |
| Aluminum potassium sulfate, | 7784-24-9 |
| dodecahydrate | |
| Aluminum sulfate, | 7784-31-8 |
| octadecahydrate | |
| (S)-(−)-Cysteine | 52-90-4 |
| p-Toluenesulfonic Acid | 104-15-4 |
| Potassium bitartrate | 868-14-4 |
| DL-aspartic acid | 617-45-8 |
| p-Dimethylaminobenzaldehyde | 100-10-7 |
| Sodium salicylate | 54-21-7 |
| Benzoin | 119-53-9 |
| Sodium dodecyl sulfate | 151-21-3 |
| L-Mcnthol | 2216-51-5 |
| Tiron | 149-45-1 |
| Riboflavin | 83-88-5 |
| Sodium Acetate Trihydrate | 6131-90-4 |
| Disodium Succinate | 6106-21-4 |
| Hexahydrate | |
| Disodium | 6381-92-6 |
| ethylenediaminetetraacetate | |
| dihydrate | |
| sodium citrate, dihydratc | 1545801 |
| Sodium potassium tartrate, | 6381-59-5 |
| tetrahydate | |
| L-(+)-Arginine | 1119-34-2 |
| monohydrochloride | |
| Ethylenediamine | 333-18-6 |
| dihydrochloride | |
| Sodium formate | 141-53-7 |
| Sodium acetate | 127-09-3 |
| Potassium acetate | 127-08-2 |
| Ammonium citrate | 3012-65-5 |
| Ammonium bicarbonate | 1066-33-7 |
| Ammonium chloride | 12125-02-9 |
| Ammonium nitrate | 6484-52-2 |
| Ammonium persulfate | 7727-54-0 |
| Ammonium sulfate | 7783-20-2 |
| Zinc chloride | 7646-85-7 |
| Sulfuric acid, zinc salt | 7446-20-0 |
| (1:1), heptahydrate | |
| Sodium Tripolyphosphate | 7758-29-4 |
| ammoniuni benzoate | 1863-63-4 |
| ammonium bisulfite | 10192-30-0 |
| I,5-Naphthalenedisulfonic Acid | 1655-29-4 |
| Disodium Salt | |
| 4-Hydroxybenzoic Acid | 99-96-7 |
| Diphenylacetic Acid | 117-34-0 |
| Glutaric Acid | 110-94-1 |
| L-(−)-Fucose | 2438-80-4 |
| L-Cysteine Hydrochloride | 52-89-1 |
| L-Histidine Hydrochloride | 1880304 |
| Monohydrate | |
| o-Toluic Acid | 118-90-1 |
| Pivalic Acid | 75-98-9 |
| Pyruvic Acid Sodium Salt | 113-24-6 |
| Potassium bromide | 2139626 |
| Sodium Dithionate Dihydrate | 7631-94-9 |
| Sodium Malonate | 141-95-7 |
| Trisodiuin Citrate | 68-04-2 |
| Potassium Sodium Tartratc | 304-59-6 |
| Potassium Citrate | 866-84-2 |
| D-Maltose Monohydrate | 6363-53-7 |
| Cyclohexaamylose | 10016-20-3 |
| Dodecyl sulfate, lithium salt | 2044-56-6 |
| Manganese chloride | 2145076 |
| methyl-urea | 598-50-5 |
| beta-Cyclodextrin | 7585-39-9 |
| Triphosphoric acid, | 13845-36-8 |
| pentapotassium salt | |
| Glycine ethyl ester | 623-33-6 |
| hydrochloride | |
| L-Histidine methyl cster | 7389-87-9 |
| dihydrochloride | |
| L-Leucine methyl ester | 7517-19-3 |
| hydrochloride | |
| D-Lysinc hydrochloride | 7274-88-6 |
| 2-Naphthalenesulfonic acid | 532-02-5 |
| sodium salt | |
| calcium nitrate tetrahydrate | 13477-34-4 |
| Vitamin B1 | 59-43-8 |
| Zinc Acetate Dihydrate | 5970-45-6 |
| Potassium fluoride | 7789-23-3 |
| Potassium iodate | 2139718 |
| Potassium iodide | 7681-11-0 |
| Potassium thiocyanate | 333-20-0 |
| Sodium bromide | 7647-15-6 |
| Sodium fluoride | 7681-49-4 |
| Sodium iodide | 7681-82-5 |
| Sodium nitrate | 7631-99-4 |
| Calcium acetate | 5743-26-0 |
| Trichloroacetic acid | 76-03-9 |
| Ammonium acetate | 631-61-8 |
| Ammonium fluoride | 12125-01-8 |
| DL-malic acid | 617-48-1 |
| t-Butyl Alcohol | 75-65-0 |
| beta-Alanine | 107-95-9 |
| (S)-(−)-Tryptophan | 73-22-3 |
| Malonic acid | 141-82-2 |
| Phenethylamine | 64-04-0 |
| Salicylylaldehyde | 90-02-8 |
| Sodium benzoate | 532-32-1 |
| Mandelic acid | 90-64-2 |
| Calcium pantothenatc | 137-08-6 |
| Chloroacetic Acid | 79-11-8 |
| Ethanol Amine | 141-43-5 |
| Salicylic acid | 69-72-7 |
| Saccharin sodium | 128-44-9 |
| Thiamine hydrochloride | 67-03-8 |
| 2,2′-Oxybisethanol | 111-46-6 |
| Resorcinol | 108-46-3 |
| 2-Amino-2-(hydroxymcthyl)-1,3- | 77-86-1 |
| propanediol | |
| 2,5-Dimethylphenol | 95-87-4 |
| Ammonium Phosphate | 7722-76-1 |
| Monobasic | |
| 1,3-Butanediol | 107-88-0 |
| Glycolic Acid | 79-14-1 |
| Sodium Gluconate | 527-07-1 |
| Terephthalic Acid | 100-21-0 |
| L-Ascorbic Acid Sodium Salt | 134-03-2 |
| 3-Acetyl-6-methyl-2,4- | 520-45-6 |
| pyrandione | |
| Calcium Acetate | 62-54-4 |
| Nicotinamide | 98-92-0 |
| 1-Hydroxy-2-naphthoic Acid | 86-48-6 |
| 2-Isopropylphenol | 88-69-7 |
| 4-Aminosalicylic Acid | 65-49-6 |
| Calcium Glycerophosphate | 27214-00-2 |
| Erythorbic Acid Sodium Salt | 7378-23-6 |
| Gluconic Acid Potassium Salt | 299-27-4 |
| Orotic Acid | 65-86-1 |
| p-Anise Alcohol | 105-13-5 |
| Potassium Benzoate | 582-25-2 |
| Taurine | 107-35-7 |
| Thiaminc Nitrate | 532-43-4 |
| 3,3,5-Trimethyl-1-cyclohexanol | 116-02-9 |
| tert-Butylhydroquinone | 1948-33-0 |
| Sulfosalicylic acid | 97-05-2 |
| Gallic acid | 149-91-7 |
| L-borneol | 464-45-9 |
| Isoborneol | 124-76-5 |
| 2,5-Dihydroxybenzoic acid, | 490-79-9 |
| Gentisic acid | |
| 5-hydroxy-6-methyl-3,4- | 65-23-6 |
| pyridinedimethanol | |
| Naphthalene-2-sulfonic acid | 120-18-3 |
| Ethanesulfonic acid, 2- | 1562-00-1 |
| hydroxy-, monosodium salt | |
| Pamoic acid | 130-85-8 |
| 2,4-Dimethylphenol | 105-67-9 |
| 3,5-Dihydroxyacetophenone | 51863-60-6 |
| Eugenol | 97-53-0 |
| n-Butyric Acid | 107-92-6 |
| Hydroquinone | 123-31-9 |
| Propionic Acid | 79-09-4 |
| meta-Phenylenediamine | 108-45-2 |
| Oxalic Acid | 144-62-7 |
| n-Hexanoic Acid | 142-62-1 |
| 2-Furancarboxylic Acid | 88-14-2 |
| 4′-Nitroacetanilide | 104-04-1 |
| D-(−)-Tartaric Acid | 147-71-7 |
| p-Acetamidobenzoic Acid | 556-08-1 |
| Galactaric acid | 526-99-8 |
| D-glucuronate | 1700908 |
| Lactobionic acid | 96-82-2 |
| p-Formylacetanilide | 122-85-0 |
| 2-Mcrcaptobenzoic acid | 147-93-3 |
| Propanoic acid, 2-hydroxy-, | 28305-25-1 |
| calcium salt (2:1), (5)- | |
| D(+)-10-Camphorsulfonic acid | 3144-16-9 |
| 3-Cyclopentylpropionic acid | 140-77-2 |
| 1R-(−)-Camphorsulfonic acid | 35963-20-3 |
| DL-Lysine | 70-54-2 |
| Cinnamic acid | 621-82-9 |
| Triethanolaminc | 102-71-6 |
| Acetic Acid | 64-19-7 |
| Dichloroacctic Acid | 79-43-6 |
| Diethylamine | 109-89-7 |
| Diethylaminoethanol | 100-37-8 |
| N-(2-Hydroxyethyl)Morpholine | 622-40-2 |
| Octanoic Acid | 124-07-2 |
| isobutyric acid | 79-31-2 |
| Anisic Acid | 100-09-4 |
| Betaine | 107-43-7 |
| Enanthoic Acid | 111-14-8 |
| Hippuric Acid | 495-69-2 |
| Tiglic Acid | 80-59-1 |
| Cyclohexanecarboxylic acid | 98-89-5 |
| m-Methoxybenzoic acid | 586-38-9 |
| D-(+)-Camphoric acid | 124-83-4 |
| N-(2-Hydxoxyethyl)pyrrolidine | 2955-88-6 |
| Sodium Metabisulfite | 7681-57-4 |
| sodium hydrogen phosphate | 7558-79-4 |
| Sodium Phosphate Monobasic | 7558-80-7 |
| Sodium thiosulfate | 7772-98-71 |
| Orthoboric acid | 10043-35-3 |
| Diethanolamine | 111-42-2 |
| Benzaldehyde | 100-52-7 |
| Sorbic acid | 110-44-1 |
| L-(+)-Tartaric Acid | 87-69-4 |
| D-mannitol | 69-65-8 |
| Butyl paraben | 94-26-8 |
| Thymol | 89-83-8 |
| Methyl salicylatc | 119-36-8 |
| Citric acid | 77-92-9 |
| Creatinine | 60-27-5 |
| Vitamin C | 50-81-7 |
| Bcnzoic Acid | 65-85-0 |
| Methyl 4-hydroxybenzoate | 99-76-3 |
| in-Cresol | 108-39-4 |
| p-Cresol | 106-44-5 |
| Aspirin | 50-78-2 |
| Phenol | 108-95-2 |
| Sucrose | 57-50-1 |
| Potassium citrate, monohydrate | 1534146 |
| Sodium acetate | 127-09-3 |
| Lactic acid | 50-21-5 |
| Propionic acid, sodium salt | 65-85 |
| Benozyl alcohol | 100-51-6 |
| Phenethyl alcohol | 60-12-8 |
| Cholesterol | 57-88-5 |
| D-Glucose | 50-99-7 |
| Sorbitol | 50-70-4 |
| Aspartame | 22839-47-0 |
| Saccharin | 81-07-2 |
| 2,6-Di-tert-Butyl-p-Cresol | 128-37-0 |
| 4-Chloro-3-methylphenol | 59-50-7 |
| glycerin | 56-81-5 |
| Propyl paraben | 94-13-3 |
| fumaric acid | 110-17-8 |
| dabco | 280-57-9 |
| p-Phenylenediamine | 106-50-3 |
| Anethole | 4180-23-8 |
| propyl gallate | 121-79-9 |
| L-monosodium glutamate | 142-47-2 |
| Butylated hydroxyanisole | 25013-16-5 |
| Cyclohexanol, 5-methyl-2-(1- | 89-78-1 |
| methylethyl)-, | |
| (1alpha, 2beta, 5alpha)- | |
| alpha-Thioglycerol | 96-27-5 |
| Sodium dehydroacetate | 4418-26-2 |
| Ethyl 4-hydroxybenzoate | 120-47-8 |
| Ethyl Vanillin | 121-32-4 |
| Triacetin | 102-76-1 |
| Potassium sorbate | 590-00-1 |
| Triethyl citrate | 77-93-0 |
| (S)-(+)-Arginine | 74-79-3 |
| Glycine | 56-40-6 |
| (S)-(−)-Histidine | 71-00-1 |
| (S)-(+)-Lysine | 56-87-1 |
| Quinone | 106-51-4 |
| Naphthalene, 2-ethoxy- | 93-18-5 |
| Methanesulfonic Acid | 75-75-2 |
| DL-Tartaric Acid | 133-37-9 |
| Cyclamic acid | 100-88-9 |
| (S)-(−)-Phenylalanine | 63-91-2 |
| (S)-(−)-Tyrosine | 60-18-4 |
| Carvone | 99-49-0 |
| Ethyl butyrate | 105-54-4 |
| 6-Methyl-5-hepten-2-one | 110-93-0 |
| Ethyl acetoacetate | 141-97-9 |
| Methyl benzoate | 93-58-3 |
| Phenylacetic Acid | 103-82-2 |
| Adipic acid | 124-04-9 |
| Ethyl benzoate | 93-89-0 |
| Benzyl benzoate | 120-51-4 |
| Pyruvic acid | 127-17-3 |
| Succinic acid | 110-15-6 |
| Indole | 120-72-9 |
| Methyl anthranilate | 134-20-3 |
| Diethyl malonate | 105-53-3 |
| Niacin | 59-67-6 |
| Meso-inositol | 87-89-8 |
| 4-Aminobenzoic acid | 150-13-0 |
| Anisole | 100-66-3 |
| Urea | 57-13-6 |
| Pyrrolidinc | 123-75-1 |
| Cyclopentanone | 120-92-3 |
| Acetic anhydride | 108-24-7 |
| Benzophenone | 119-61-9 |
| D-(−)-Fructose | 57-48-7 |
| D-(+)-Xylose | 58-86-6 |
| o-Methoxybenzoic Acid | 579-75-9 |
| linalool | 78-70-6 |
| ethyl isovalerate | 108-64-5 |
| 1,1′-Azobisformamide | 123-77-3 |
| 6-Methylcourmarin | 92-48-8 |
| acetoin | 513-86-0 |
| alpha-Phellandrene | 99-83-2 |
| Cymene | 99-87-6 |
| Dimethyl succinate | 106-65-0 |
| p-Anisaldehyde | 123-11-5 |
| Phenyl ether | 101-84-8 |
| Tetrahydro-2-furanmethanol | 97-99-4 |
| Valeric Acid | 109-52-4 |
| 3,4-xylenol | 95-65-8 |
| 1,1-diethoxyethane | 105-57-7 |
| ethyl butyraldehyde | 97-96-1 |
| Ethyl crotonate | 623-70-1 |
| ethyl isobtyrate | 97-62-1 |
| methyl isovalerate | 556-24-1 |
| methyl propionate | 554-12-1 |
| methyl valeraldehyde | 123-15-9 |
| 4-(2,6,6-Trimethyl-2-cyclohexen- | 127-41-3 |
| 1-yl)- | |
| 3-buten-2-one | |
| 4-(2,6,6-trimethyl-1- | 14901-07-6 |
| cyclohexen-1-yl)-3-buten-2-one | |
| Maleic acid | 110-16-7 |
| 3-Methylbutanoic acid | 503-74-2 |
| L-Glutamic Acid | 56-86-0 |
| D-limonene | 5989-27-5 |
| 1-Penyl-1-proponal | 93-54-9 |
| 2′-Hydroxyacetophenone | 118-93-4 |
| 2,4-Dihydroxybenzoic Acid | 89-86-1 |
| 2-Phenyl-1-propanol | 1123-85-9 |
| 3-Phenylpropionic Acid | 501-52-0 |
| 4-Ethoxyphenol | 622-62-8 |
| Alpha-Terpineol | 98-55-5 |
| Bensaldehyde Dimethylacetal | 1125-88-8 |
| Benzyl Ether | 103-50-4 |
| Benzyl Formate | 104-57-4 |
| Benzyl Salicylate | 118-58-1 |
| Cinnamyl Alcohol | 104-54-1 |
| D-(+)-Glucono-1,5-lactone | 4253-68-3 |
| D-Isoascorbic Acid | 89-65-6 |
| 2,3-Naphthalenediol | 92-44-4 |
| Diethyl Succinate | 123-25-1 |
| Ethyl 2-Aminobenzoate | 87-25-2 |
| Ethyl Cinnamate | 103-36-6 |
| Ethyl Phenylacetate | 101-97-3 |
| Ethyl Salicylate | 118-61-6 |
| gamma-Valerolactone | 108-29-2 |
| hydroquinone Dimethyl Ether | 150-78-7 |
| Isocapriic Acid | 646-07-1 |
| Isoeugenol | 97-54-1 |
| Isopropyl Benzoate | 939-48-0 |
| L-(+)-Isoleucine | 73-32-5 |
| L-Malic acid | 97-67-6 |
| L-2-Aminopropionic Acid | 56-41-7 |
| L-Carnitine | 541-15-1 |
| L-Glutamine | 56-85-9 |
| L-Hydroxyproline | 51-35-4 |
| L-Proline | 147-85-3 |
| L-Serine | 56-45-1 |
| L-Threonine | 72-19-5 |
| L-Valine | 72-18-4 |
| Phenoxyacetic Acid | 122-59-8 |
| Veratrole | 91-16-7 |
| 2-Ethylbutyric acid | 88-09-5 |
| 2-Methylpyyrazine | 109-08-0 |
| o-methoxybenzaldehyde | 135-02-4 |
| L-Leucine | 61-90-5 |
| L-Asparagine | 70-47-3 |
| propiophenone | 93-55-0 |
| 5-isopropyl-2-methyl-phenol | 499-75-2 |
| Xylitol | 87-99-0 |
| ethyl 4-oxopentancoate | 539-88-8 |
| methyl cinnamate | 103-26-4 |
| cumic alcohol | 536-60-7 |
| methl 2-naphthyl ketone | 93-08-3 |
| 1-methyl-1-(1-methylethyl)- | 99-85-4 |
| 1,4-Cyclohexadiene | |
| en-ethylene diamine | |
| Caffeine | 58-08-2 |
| 5-methylfurfural | 620-02-0 |
| furfuryl acetate | 623-17-6 |
| terpinen-4-ol | 10482-56-1 |
| phenylethanal | 122-78-1 |
| 4′-Methoxyacetophenone | 100-06-1 |
| D-Fenchome | 4695-62-9 |
| 1-Methoxy-4-methylbenzene | 104-93-8 |
| o-methylanisole | 578-58-5 |
| Acetylacetaldehyde dimethyl | 5436-21-5 |
| acetal | |
| p-methylacetophenome | 122-00-9 |
| Methyl phenylacetate | 101-41-7 |
| 4-Ethoxybenzaldehyde | 10031-82-0 |
| p-tolyl acetate | 140-39-6 |
| 2,6-Dimethoxyphenol | 91-10-1 |
| Methyl 2-methoxybenzoate | 606-45-1 |
| alpha-methylcinnamaldehyde | 101-39-3 |
| 2-methoxycinnamaldehyde | 60125-24-8 |
| Potassium bicarbonate | 298-14-6 |
| piperonyl acetate | 326-61-4 |
| 2,3-hexanedione | 3848-24-6 |
| furfural acetone | 623-15-4 |
| trans beta-(2-furyl)acrolein | 623-30-3 |
| carveol | 99-48-9 |
| Methyl nicotinate | 93-60-7 |
| Ethyl benzoylacetate | 94-02-0 |
| Methyl 4-methoxybenzoate | 121-98-2 |
| Levulinic acid | 123-76-2 |
| m-Dimethoxybenzene | 151-10-0 |
| 2-acetylpyridine | 1122-62-9 |
| tetramethyl-pyrazine | 1124-11-4 |
| 2,3-dimethyl-pyrazine | 5910-89-4 |
| trimethyl-pyrazine | 14667-55-1 |
| 2-ethyl-3-methyl-pyrazine | 15707-23-0 |
| 5-Methyl-3H-furan-2-one | 591-12-8 |
| 2-Methoxy-4-methylphenol | 93-51-6 |
| piperazine | 110-85-0 |
| 2-Methoxy-4-propylphenol | 2785-87-7 |
| Naphthalene,2-(2- | 2173-57-1 |
| methylpropoxy)- | |
| 2-Acetyl-1-methylpyrrole | 932-16-1 |
| 3,3-Dimethylacrylic acid | 541-47-9 |
| Ethyl sorbate | 2396-84-1 |
| 4-(4-Hydroxyphenyl)-2-butanone | 5471-51-2 |
| 4-Methoxyphenylacetone | 122-84-9 |
| (−)-Myrtenal | 564-94-3 |
| 3-Phenylpropionaldehyde | 104-53-0 |
| 1-Phenylethyl propionate | 120-45-6 |
| 2-Methyltetrahydrofuran-3-one | 3188-00-9 |
| Cinnamyl acetate | 103-54-8 |
| Styrallyl acetate | 93-92-5 |
| Ethyl 4-methoxybenzoate | 94-30-4 |
| Benzyl propionate | 122-63-4 |
| Phenylpyruvate | 156-06-9 |
| furaneol | 3658-77-3 |
| methyl 2-methylbutanoate | 868-57-5 |
| Benzeneacetaldehyde, alpha- | 93-53-8 |
| methyl- | |
| Dimethyl anthranilate | 85-91-6 |
| 1,1-Dimethoxy-2-phenylpropane | 90-87-9 |
| 4-hexanolide | 695-06-7 |
| Dimethylbenzylcarbinyl acetate | 151-05-3 |
| Benzyl isobutyrate | 103-28-6 |
| Acetyl isoeugenol | 93-29-8 |
| 2-Acetyl-5-methyl furan | 1193-79-9 |
| Alpha-methyl-p- | 103-95-7 |
| isopropylphenylpropanaldehyde | |
| Benzylcarbinyl formate | 104-62-1 |
| p-Cresyl alpha-toluate | 101-94-0 |
| Potassium bisulfate | 7646-93-7 |
| Potassium carbonate | 584-08-7 |
| Postassium chloride | 7447-40-7 |
| Potassium hydroxide | 1310-58-3 |
| Ethyl tiglate | 5837-78-5 |
| Nerol oxide | 1786-08-9 |
| DL-Tetrohydrofurfuryl | 637-65-0 |
| propionate | |
| Benzaldehyde propylene glycol | 2568-25-4 |
| acetal | |
| 2-Methyl-3-(2-furyl) acrolein | 874-66-8 |
| vanillin | 121-33-5 |
| Cholic acid | 81-25-4 |
| R-Carvone | 6485-40-1 |
| Potassium nitrate | 7757-79-1 |
| Potassium permanganate | 7722-64-7 |
| Potassium persulfate | 7727-21-1 |
| Postassium phosphate, dibasic | 2139900 |
| Potassium Phosphate | 7778-77-0 |
| Monobasic | |
| Potassium sulfate | 7778-80-5 |
| Sodium bicarbonate | 144-55-8 |
| Sodium bisulfite | 7631-90-5 |
| Sodium carbonate | 497-19-8 |
| Sodium chloride | 7647-14-5 |
| Sodium dithionite | 7775-14-6 |
| Sodium hydroxide | 1310-73-2 |
| Sodium nitrite | 7632-00-0 |
| Sodium Pyrophosphate | 7722-88-5 |
| Sodium sulfate | 7757-82-6 |
| Sodium sulfite | 7757-83-7 |
| Sodium thiocyanate | 540-72-7 |
| Calcium Carbonate | 471-34-1 |
| Calcium chloride | 10043-52-4 |
| Calcium gluconate | 299-28-5 |
| Calcium hydroxide | 1305-62-0 |
| Calcium phosphate, dibasic | 7757-93-9 |
| Calcium sulfate | 7778-18-9 |
| N-Methyl-D-glucamine | 6284-40-8 |
| Calcium oxide | 1305-78-8 |
| Calcium Phosphate Monobasic | 7758-23-8 |
| Magnesium chloride | 7791-18-6 |
| hexahydrate | |
| Magnesium sulfate | 7487-88-9 |
| Magnesium Sulfate | 10034-99-8 |
| Heptahydrate | |
| Aluminum chloride hexahydrate | 7784-13-6 |
| aluminum nitrate nonahydrate | 7784-27-2 |
| Aluminum potassium sulfate, | 7784-24-9 |
| dodecahydrate | |
| Aluminum sulfate, | 7784-31-8 |
| octadecahydrate | |
| (S)-(−) Cysteine | 52-90-4 |
| p-Toluenesulfonic Acid | 104-15-4 |
| Potassium bitartrate | 868-14-4 |
| DL-aspartic acid | 617-45-8 |
| p-Dimethylaminobenzaldehyde | 100-10-7 |
| Sodium salicylate | 54-21-7 |
| Benzoin | 119-53-9 |
| Sodium dodecyl sulfate | 151-21-3 |
| L-Menthol | 2216-51-5 |
| Tiron | 149-45-1 |
| Riboflavin | 83-88-5 |
| Sodium Acetate Trihydrate | 6131-90-4 |
| Disodium Succinate | 6106-21-4 |
| Hexahydrate | |
| Disodium | 6381-92-6 |
| ethylenediaminetetraacetate | |
| dihydrate | |
| sodium citrate, dihydrate | 1545801 |
| Sodium potassium tartrate, | 6381-59-5 |
| tetrahydrate | |
| L-(+)-Arginine | 1119-34-2 |
| monohydrochloride | |
| Ethylenediamine | 333-18-6 |
| dihydrochloride | |
| Sodium formate | 141-53-7 |
| Sodium acetate | 127-09-3 |
| Potassium acetate | 127-08-2 |
| Ammonium citrate | 3012-65-5 |
| Ammonium bicarbonate | 1066-33-7 |
| Ammonium chloride | 12125-02-9 |
| Ammonium nitrate | 6484-52-2 |
| Ammonium persulfate | 7727-54-0 |
| Ammonium sulfate | 7783-20-2 |
| Zinc chloride | 7646-85-7 |
| Sulfuric acid, zinc salt | 7446-20-0 |
| (1:1), heptahydrate | |
| Sodium Tripolyphosphate | 7758-29-4 |
| ammonium benzoate | 1863-63-4 |
| ammonium bisulfite | 10192-30-0 |
| 1,5-Naphthalenedisulfonic Acid | 1655-29-4 |
| Disodium Salt | |
| 4-Hydroxybenzoic Acid | 99-96-7 |
| Diphenylacetic Acid | 117-34-0 |
| Glutaric Acid | 110-94-1 |
| L-(−)-Flucose | 2438-80-4 |
| L-Cysteine Hydrochloride | 52-89-1 |
| L-Histidine Hydrochloride | 1880304 |
| Monohydrate | |
| o-Toluic Acid | 118-90-1 |
| Pivalic Acid | 75-98-9 |
| Pyruvic Acid Sodium Salt | 113-24-6 |
| Potassium bromide | 2139626 |
| Sodium Dithionate Dihydrate | 7631-94-9 |
| Sodium Malonate | 141-95-7 |
| Trisodium Citrate | 68-04-2 |
| Potassium Sodium Tartrate | 304-59-6 |
| Potassium Citrate | 866-84-2 |
| D-Maltose Monohydrate | 6363-53-7 |
| Cyclohexaamylose | 10016-20-3 |
| Dodecyl sulfate, lithium salt | 2044-56-6 |
| Manganese chloride | 2145076 |
| methyl-urea | 598-50-5 |
| beta-Cyclodextrin | 7585-39-9 |
| Triphosphoric acid, | 13845-36-8 |
| pentapotassium salt | |
| Glycine ethyl ester | 623-33-6 |
| hydrochloride | |
| L-Histidine methyl ester | 7389-87-9 |
| dihydrochloride | |
| L-Leucine methyl ester | 7517-19-3 |
| hydrochloride | |
| D-Lysine hydrochloride | 7274-88-6 |
| 2-Naphthalenesulfonic acid | 532-02-5 |
| sodium salt | |
| calcium nitrate tetrahydrate | 13477-34-4 |
| Vitamin B1 | 59-43-8 |
| Zinc Acetate Dihydrate | 5970-45-6 |
| Potassium fluoride | 7789-23-3 |
| Potassium iodate | 2139718 |
| Potassium iodide | 7681-11-0 |
| Potassium thiocyanate | 333-20-0 |
| Sodium bromide | 7647-15-6 |
| Sodium fluoride | 7681-49-4 |
| Sodium iodide | 7681-82-5 |
| Sodium nitrate | 7631-99-4 |
| Calcium acetate | 5743-26-0 |
| Trichloroacetic acid | 76-03-9 |
| Ammonium fluoride | 631-61-8 |
| DL-malic acid | 12125-01-8 |
| t-Butyl Alcohol | 617-48-1 |
| beta-Alanine | 75-65-0 |
| (S)-(−) Tryptophan | 107-95-9 |
| Malonic acid | 141-82-2 |
| Phenethylamine | 64-04-0 |
| Salicylylaldehyde | 90-02-8 |
| Sodium benzoate | 532-32-1 |
| Mandelic acid | 90-64-2 |
| Calcium panthothanate | 137-08-6 |
| Chloroacetic Acid | 79-11-8 |
| Ethanol Amine | 141-43-5 |
| Salicyclic acid | 69-72-7 |
| Saccharin sodium | 128-44-9 |
| Thiamine hydrochloride | 67-03-8 |
| 2,2′-oxybisethanol | 111-46-6 |
| Resorcinol | 108-46-3 |
| 2-Amino-2-(hydroxymethyl)-1,3- | 77-86-1 |
| propanediol | |
| 2,5-Dimethylphenol | 95-87-4 |
| Ammonium Phosphate | 7722-76-1 |
| Monobasic | |
| 1,3-Butanediol | 107-88-0 |
| Glycolic Acid | 79-14-1 |
| Sodium Gluconate | 527-07-1 |
| Terephthalic Acid | 100-21-0 |
| L-Ascorbic Acid Sodium Salt | 134-03-2 |
| 3-Acetyl-6-methyl-2,4- | 520-45-6 |
| pyrandione | |
| Calcium Acetate | 62-54-4 |
| Nicotinamide | 98-92-0 |
| 1-Hydroxy-2-naphthoic Acid | 86-48-6 |
| 2-Isopropylphenol | 88-69-7 |
| 4-Aminosalicyclic Acid | 65-49-6 |
| Calcium Glycerophosphate | 27214-00-2 |
| Erythorbic Acid Sodium Salt | 7378-23-6 |
| Gluconic Acid Potassium Salt | 299-27-4 |
| Orotic Acid | 65-86-1 |
| p-Anise Alcohol | 105-13-5 |
| Potassium Benzoate | 582-25-2 |
| Taurine | 107-35-7 |
| Thiamine Nitrate | 532-43-4 |
| 3,3,5-Timethyl-1-cyclohexanol | 116-02-9 |
| tert-Butylhydroquinone | 1948-33-0 |
| Sulfosalicyclic acid | 97-05-2 |
| Gallic acid | 149-91-7 |
| L-borneol | 464-45-9 |
| Isoborneol | 124-76-5 |
| 2,5-Dihdroxybenzoic acid, | 490-79-9 |
| Gentisic acid | |
| 5-hydroxy-6-methyl-3,4- | 65-23-6 |
| pyridinedimethanol | |
| Naphthalene-2-sulfonic acid | 120-18-3 |
| Ethanesulfonic acid, 2-hydroxy-, | 1562-00-1 |
| monosodium salt | |
| Pamoic acid | 130-85-8 |
| 2,4-Dimethylphenol | 105-67-9 |
| 3,5-Dihydroxyacetophenone | 51863-60-6 |
| Eugenol | 97-53-0 |
| n-Butyric Acid | 107-92-6 |
| Hydroquinone | 123-31-9 |
| Propionic Acid | 79-09-4 |
| meta-Phenylenediamine | 108-45-2 |
| Oxalic Acid | 144-62-7 |
| n-Hexanoic Acid | 142-62-1 |
| 2-Furancarboxylic Acid | 88-14-2 |
| 4′-Nitroacetanilide | 104-04-1 |
| D-(−)-Tartaric Acid | 147-71-7 |
| p-Acetamidobenzoic Acid | 556-08-1 |
| Galactaric acid | 526-99-8 |
| D-glucuronate | 1700908 |
| Lactobionic acid | 96-82-2 |
| p-Formylacetanilide | 122-85-0 |
| 2-Mercaptobenzoic acid | 147-93-3 |
| Propanoic acid, 2-hydrox-, | 28305-25-1 |
| calcium salt (2:1), (S)- | |
| D(+)-10-Camphorsulfonic acid | 3144-16-9 |
| 3-Cyclopentylpropionic acid | 140-77-2 |
| 1R-(−)Camphorsulfonic acid | 35963-20-3 |
| DL-Lysine | 70-54-2 |
| Cinnamic acid | 621-82-9 |
| Triethanolamine | 102-71-6 |
| Acetic Acid | 64-19-7 |
| Dichioroacetic Acid | 79-43-6 |
| Diethylamine | 109-89-7 |
| Diethylaminoethanol | 100-37-8 |
| N-(2-Hydroxyethyl)Morpholine | 622-40-2 |
| Octanoic Acid | 124-07-2 |
| isobutyric acid | 79-31-2 |
| Anisic Acid | 100-09-4 |
| Betaine | 107-43-7 |
| Enantoic Acid | 111-14-8 |
| Hippuric Acid | 495-69-2 |
| Tiglic Acid | 80-59-1 |
| Cyclohexanecarboxylic acid | 98-89-5 |
| m-Methoxybenzoic acid | 586-38-9 |
| D-(+)-Camphoric acid | 124-83-4 |
| N-(2-Hydroxyethyl)pyrrolidine | 2955-88-6 |

Ionic guests are salts themselves, and may be formed from bases and acids prior to being used to form cocrystals. For example, the following bases and acids may be reacted to form ionic guests:

Bases

Ammonia
L-Arginine
Benethamine
Benzathine
Betaine
Calcium Hydroxide
Choline
Deanol
Diethanolamine
Dietbylamine
2-(Diethylamino)ethanol
2-Aminoethanol
Ethylenediamine
N-Methylglucamine
Hydrabamine
1H-Imidazole
Lysine
Magnesium Hydroxide
Morpholine
4-(2-Hydroxyethyl)Morpholine
piperazine
Potassium Hydroxide
Pyrrolidine
1-(2-Hydroxyethyl)Pyrrolidine
Sodium Hydroxide
Triethanolamine
Tromethamine
Zinc Hydroxide
   Acids
(+)-L-Tartaric Acid
1,2,2-Trimethyl-1,3-cyclopentanedicarboxylic Acid
10-Undecylenic Acid
1-Hydroxy-2-naphthoic Acid
(+)-Camphor-I0-sulfonic Acid
2,5-Dihydroxybenzoic Acid
2-Furancarboxylic Acid
2-Mercaptobenzoic Acid
3-Cyclopentylpropionic Acid
3-Phenylpropionic Acid
4-Aminosalicylic Acid
4-Hydroxybenzoic Acid
Acetic Acid
Adipic Acid
alpha-Hydroxypropionic Acid
Benzenesulfonic Acid
Benzoic Acid
Carbonic Acid
Cholic Acid
Citric Acid
(−)-D-Tartaric Acid
(+)-D-Camphoric Acid
(+)-D-Malic Acid
(+)-L-Malic Acid
2,2-Dichloroacetic Acid
DL-10-Camphorsulfonic Acid
DL-Glutamic Acid
DL-Malic Acid
DL-Tartaric Acid
Dodecylsulfuric Acid
Ethanesulfonic Acid
Ethylenediaminetetraacetic Acid
Ethylsulfuric Acid
Fumaric Acid
Galactaric Acid
Gallic Acid
Gluconic Acid
Glutaric Acid
Glycolic Acid
Hippuric Acid
Hydriodic Acid
Hydrobromic Acid
Hydrochloric Acid
(−)-L-Apple Acid
(÷)-L-Lactic Acid
(+)-L-′Tartaric Acid
D,L-Lactic Acid
Lactobionic Acid
L-Aspartic Acid
Lauric Acid
L-Glutamic Acid
Maleic Acid
(−)-L-Malic Acid
Malonic Acid
D,L-Mandelic Acid
Methanesulfonic Acid
Naphthalene-2-sulfonic acid
n-Butyric Acid
n-Decanoic Acid
n-Hexanoic Acid
Nitric acid
n-Tetradecanoic Acid
Octanoic Acid
Oleic Acid
Orotic Acid
Orthoboric Acid
Oxalic Acid
4-Acetamidobenzoic Acid
Palmitic Acid
Pamoic Acid
Phosphoric Acid
Picric Acid
Pivalic Acid
Propionic Acid
p-Toluenesulfonic Acid
Pyrophosphoric Acid
Salicylic Acid
Stearic Acid
Succinic Acid
Sulfosalicylic Acid
Sulfuric Acid
Terephthalic Acid
Thiocyanic Acid
Valeric Acid
Valproic Acid

Typically, suitable guests will have complementary ability to noncovalently bond to the active agent or its salt, for example the ability to form hydrogen bonds with the active agent or its salt. Suitable guests for active agents having negative counterions include, but are not limited to, compounds having alcohol, ketone, ester, and/or carboxylic acid functionalities. Suitable guests may include organic acids, organic bases, organic salts, alcohols, aldehydes, amino acids, sugars, ionic inorganic compounds, aliphatic esters and ketones, and aromatic esters and ketones.

In one embodiment of the disclosure, guests are neutral and not liquids at room temperature. Also among the presently preferred neutral guests are carboxylic acids having at least three carbon atoms, alternatively at least four carbon atoms, and which do not form solvates. For example, if the following acids were combined with active agents, the combination would more properly be considered a solvate than a cocrystal: acetic acid, propionic acid, and butyric acid. However, in certain embodiments of the present invention (for example, in certain cocrystals, cocrystallization methods, and screening methods), the use of solvents and solvates may still be desirable, and the use of solvents and solvates is not excluded from the scope of any cocrystal or method except where explicitly stated.

Examples of further emobodiments of the disclosure described herein are indicated below without, however, being limiting in nature.

### EXAMPLE 1

Five cocrystals of 2-4-(4-chloro-2-fluorophenoxy)phenyl]pyrimidine-4-carboxamide (Compound 1) were identified by using techniques of the disclosure. Compound 1 possesses extremely low solubility characteristics (<0.1 μg/mL) in aqueous systems. Although the permeability of Compound 1 could not be measured in Caco-2 cells because of its inherently low solubility, Compound 1 is suspected to be a Class II compound (low solubility and high permeability) as described in the biopharmaceutical drug classification scheme (BCS) (Amidon, Gordon L., Lennernaes, Hans, Shah, Vinod P. and Crison, John R. (1995) “A theoretical basis for a biopharmaceutic drug classification: the correlation of in vitro drug product dissolution and in vivo bioavailability” Pharmaceutical Research 1990, 12(3), 4 13-20). The calculated octanol/water partition coefficient (clogP) for Compound 1 is 2.9, supporting this suspicion (Yazdanian, Mehran, Glynn, Susan L., Wright, James L., and Hawi, Amale. (1998) “Correlating partitioning and Caco-2 cell permeability of structurally diverse small molecular weight compounds” Pharmaceutical Research 1998 15(9), 1490-1494). As expected with Class II BCS compounds, Compound 1 showed low in-vitro dissolution and low in-vivo plasma concentrations after oral dosing of the crystalline solid in dogs. Cocrystallization techniques were used as a tool to improve the pharmaceutical properties of Compound 1.

Physico-Chemical Characterization of Parent Compound 1 and Cocrystal 2:

Differential scanning calorimetry (DSC) was performed with a PerkinElmer, Pyris 1 DSC. Each DSC sample was sealed in a 50 μL aluminum pan with a pierced lid and heated through the respective melting temperatures at scan rates of 10° C./min. Modulated DSC was performed with a TA Instruments 2920 DSC. The amorphous glass of Compound 1 was prepared by heating at 10° C./min to 220° C. and then quickly cooling to −50° C. The glass was then heated using a modulation amplitude of ±0.80° C. and a 60 second period with an underlying heating rate of 1° C./mm. from 25 through 100° C. X-ray powder diffraction (XRPD) patterns were collected on a Philips Analytical X'Pert Plus MPD x-ray diffractometer using a Cu tube at 50 kV and 4 OmA. The scan range was 4-40 °20 with a step size of 0.02 °20/sec and the time per step of 1 second. A Surface Measurement Systems DVS-1000 was used for dynamic water sorption characterization. The sample was dried under nitrogen at 0% RH, 25° C. until the sample met equilibration conditions of less than 0.0001% weight change. The sample was cycled twice in 5% RH steps from 0 through 95% RH.

Cocrystal Screening:

Thermal microscopy methods were used to determine if a particular carboxylic acid was able to cocrystallize with Compound 1 using melt or highly saturated solution conditions. A total of 26 carboxylic acids were screened using a binary-melt technique (Kofler) on a microscope slide with mixture occurring by use of a coverslip (at the interface where the compounds mix, a molecular complex containing both components may form under appropriate conditions.) High boiling organic liquids such as methyl salicylate or methyl benzoate were used to create highly concentrated solutions in which the melting point of Compound 1 was reduced. By varying the liquid composition and concentration of each component before they were mixed, the conditions of an individual experiment could be tailored to match the particular guest being tested. A positive interaction was determined visually by observing the slide through crossed polars. In a negative interaction, the mixing of the guest and Compound 1 created a eutectic where no crystallization occurred while a positive interaction produced crystalline material at the binary interface. The products were analyzed by Raman spectroscopy. Five cocrystals were identified using this technique. A cocrystal of Compound 1 with glutaric acid was selected for further development. This cocrystal is referred to as Cocrystal 2. Thermal microscopic images were acquired using transmitted light and crossed polars on a microscope stage with temperature control.

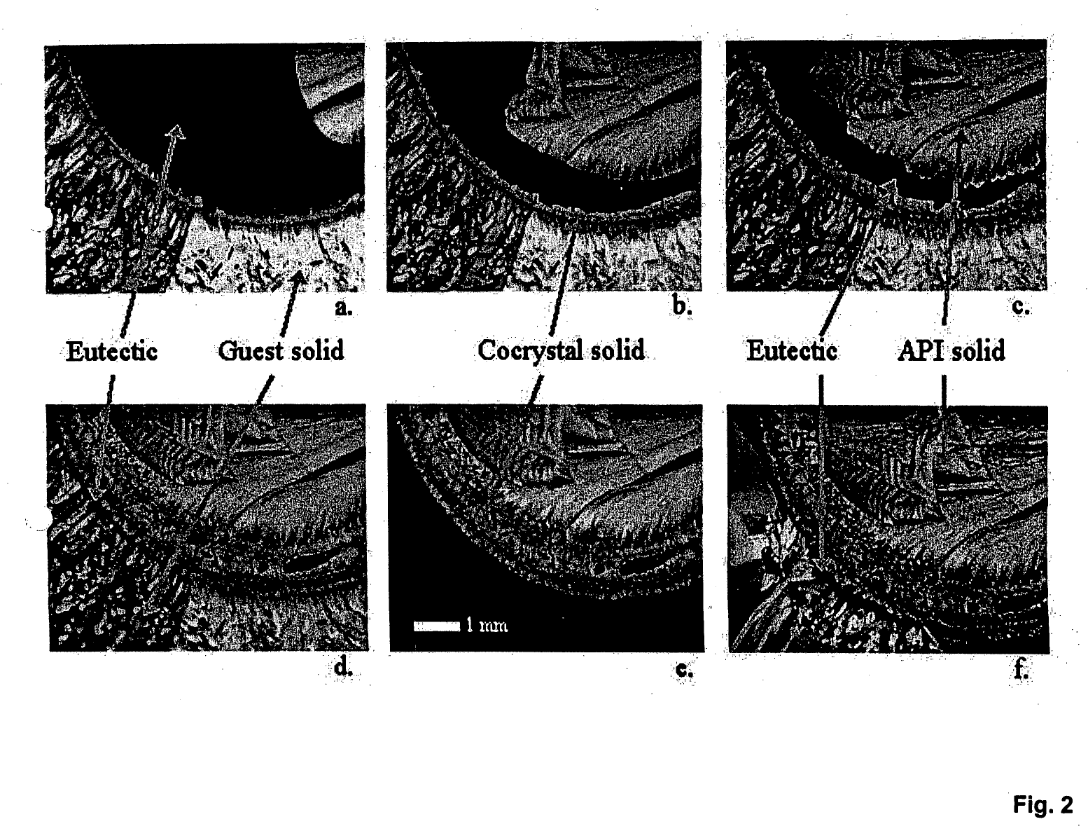

FIG. 2 shows a solution of Compound 1 dissolved in a small amount of methyl benzoate on a glass microscope slide. A solution of glutaric acid in methyl benzoate was also generated on the same slide approximately 1 cm away from the solution of Compound 1. A coverslip was applied to both solutions simultaneously, causing the two solutions to meet at an interface where they mixed by diffusion. The solutions were allowed to cool and solids were observed growing in the solution. In image (a) the solution of glutaric acid, the guest, is located in the bottom half of images. It has solidified as two domains (one bright and one darker) with a feather-like morphology. In that image, the solution of the API appears to grow solids in the top right corner of image. The interface where the two solutions have mixed is where cocrystal formation has occurred (the cocrystal is located on the edge of the guest solid domains and is bordered by the dark liquid phase). Liquid phases are dark in the images because the slide photograph was taken through crossed polarizing filters. Crystal growth on the slide was manipulated by adjusting the temperature. In images (a), (b), and (c) the cocrystal (curved line in center) shows an increasing amount of growth at the boundary of the glutaric acid domain as the crystal growth progresses from (a) to (b) to (c). The growth of the cocrystal and the API are inhibited in the eutectic area that immediately separates them as shown in image (c).

The formation of the eutectic is temperature sensitive. At temperatures near the melting point of the solids, the eutectic forms in areas where the presence of the mixture of components acts to lower the melting point of the solids. The melting point is higher in areas where the solid is in equilibrium with a solution containing a higher percentage of the components (or a high percentage of the correct ratio of components) that make up the solid. A eutectic also has formed between glutaric acid and the cocrystal. In image (d) a narrow eutectic has formed as the temperature approaches the melting point of glutaric acid. In image (e) the glutaric acid has completely melted, clearly showing the boundary of the cocrystal solid phase. When the temperature was lowered again as shown in image (I), the glutaric acid grew in and formed a eutectic with the cocrystal phase.

Synthesis of Glutaric Acid Cocrystal 2 by Solution Methods:

Compound 1 (2.898 g, 8.431 mmol) and glutaric acid (1.111 g, 8.410 mmol) were dissolved in 150 mL of boiling chloroform with stirring. The solution was concentrated by continued boiling until the volume was 50 mL. Seeds of the cocrystal generated in thermal experiments or from previous batches were introduced to the hot solution (spontaneous nucleation under these conditions always resulted in the stable form of Compound 1). Crystallization occurred rapidly and was allowed to proceed as the solution cooled over approximately 15 minutes. Approximately 100 mL of cyclohexane were added and the resulting solution was cooled on ice for 30 minutes. Cocrystal 2 was isolated by filtration and allowed to dry in the air (3.705 g, 92% yield). A single crystal was isolated from the recovered product and used in the single crystal x-ray diffraction study.

Raman Spectroscope:

Raman spectra were collected with a Chrome Sentinel dispersive Raman unit equipped with a 785 nm, 70 mW excitation laser and a TE cooled CCD (1024×256 pixels, <0.Ie−/pixel/sec). A fiber-optically coupled filtering probe was used to collect data in the spectral range 125 cm⁻¹ to 2200 cm⁻¹ at a resolution of 4 cm⁻¹. Each spectrum is a result of two co-added 20 second scans. The unit has continuous automatic calibration using an internal standard. The data were collected by SentinelSoft data acquisition software and processed in GRAMS/Al V.7.

Single Crystal X-Ray Diffraction (SCXRD):

A suitable crystal of Compound 2 was coated with Paratone N oil, suspended in a small fiber loop and placed in a cooled nitrogen gas stream at 100 K on a Bruker D8 SMART 1000 CCD sealed tube diffractometer with graphite monochromated CuK_{α} (1.54178 Å) radiation. Data were measured using a series of combinations of phi and omega scans with 10 second frame exposures and 0.3° frame widths. Data collection, indexing and initial cell refinements were all carried out using SMART software (SMART Version 5.55, 2000, Bruker AXS, Inc., Analytical X-ray Systems, 5465 East Cheryl Parkway, Madison Wis. 53711-5373). Frame integration and final cell refinements were done using SAINT software (SAINT Version 6.02, 1999, Bruker AXS, Inc., Analytical X-ray Systems, 5465 East Cheryl Parkway, Madison Wis. 53711-5373). The final cell parameters were determined from least-squares refinement on 3625 reflections. The structure was solved using Direct methods and difference Fourier techniques (SHELXTL, VS. 10) (SHELXTL VS. 10,1997, Bruker AXS, Inc., Analytical X-ray Systems, 5465 East Cheryl Parkway, Madison Wis. 53711-5373). All the hydrogen atoms were located from difference Fouriers and included in the final cycles of least squares with isotropic Uᵢⱼ's. All non-hydrogen atoms were refined anisotropically. Scattering factors and anomalous dispersion corrections are taken from the International Tables for X-ray Crystallography (A. J. C. Wilson (ed), “International Tables for X-ray Crystallography, Volume C” Kynoch, Academic Publishers, Dordrecht, 1992, Tables 6.1.1.4 (pp. 500-502) and 4.2.6.8 (pp. 219-222).). Structure solution, refinement, graphics and generation of publication materials were performed by using SHELXTL, V5.10 software.

Chemical and Physical Stability of Cocrystal 2:

Samples of cocrystal 2 were placed in glass bottles at 40° C./75% RH and 60° C. and tested periodically during two months storage. Samples were tested by XRPD, DSC, and assayed for impurities using a high performance liquid chromatography technique with ultraviolet detection (HPLC-UV) method. Cocrystal 2 was also shown to be chemically and physically stable for storage under stress conditions of 40° C./75% relative humidity (RH) and 60° C. for two months.

Intrinsic Dissolution Studies:

Intrinsic dissolution measurements were performed using a fiber optic probe (Delphian® type 11A fiber optic workstation, baseline correction mode with sample wavelength maximum of 279 nm and baseline wavelength of 350 nm) at 37° C. and 100 rpm in a USP apparatus II dissolution vessel (Vankel VK7010) containing 500 mL of pure water. Disks 0.8 cm diameter were compressed using 70 mg of solid in stainless steel dies (Vankel Woods apparatus) at 1000 lbs for 60 seconds with a Carver Press. Dissolution studies for cocrystal 2 lasted 90 minutes, after which time the disks were recovered, carefully ground and checked by XRPD for the presence of cocrystal. Due to the low solubility of Compound 1, dissolution studies were run over 24 hours in order to get a measurable rate.

Pharmacokinetic Evaluation:

A study was conducted to compare the pharmacokinetic profiles of Compound 1 and Cocrystal 2. Compound 1 and Cocrystal 2 were administered as neat solids to six male beagle dogs in a crossover study with a two-week washout period between treatments. Each dog was dosed with either Compound 1 or Cocrystal 2 in a gelatin capsule after an overnight fast. All research involving animal subjects adhered to the “Principles of Laboratory Animal Care” (NIH publication #85-23). Dose levels of 5 mg/kg and 50 mg/kg were each evaluated. Each dog received one size #2 capsule for the 5 mg/kg dose. Dosing at 50 mg/kg required use of two size #00 capsules for each dog. Blood samples were collected at intervals for 36 hours post-dose. Non-compartmental pharmacokinetic metrics were determined using WinNonlin v. 1.5 (Scientific Consulting, Inc., Mountain View, Calif.). The area under the plasma concentration-time curve (AUC) was estimated by application of the linear trapezoidal rule. Statistical analyses were conducted using Microsoft Excel 2000; statistical significance was considered when p<0.05. The glutaric acid cocrystal 2 showed an eighteen times greater intrinsic dissolution rate and three times the plasma area-under-the-curve (AUC) as compared to Compound 1 in single dose dog exposure study.

Particle Size Evaluation:

Particle size of each of the lots of Compound 1 and Cocrystal 2 dosed in the pharmacokinetic studies were characterized using an instrumented light scattering particle sizer (Malvern 2000). Samples from each lot were suspended in Millipore deionized water with S drops of Triton X-100 in 2 liters included as a dispersant. Samples were analyzed in the particle-in-liquid mode.

### EXAMPLE 2

A cocrystal screen was performed on theophylline (“api”) with a series of guest compounds. Theophylline was dissolved in ethylene glycol at ˜1:3 wt/wt api:solvent. This produced a melting point depression effect that effectively lowered the melting point of theophylline from 272° C. to about 135° C. to 140° C. Theophylline crystallized rapidly from the hot ethylene glycol solution on a slide under a coverslip. The guests were most often used neat (no ethylene glycol), but ethylene glycol was used if the melting point of the guest was higher than about 140° C. or if decomposition or sublimation occurred upon melting the pure guest. This technique was confirmed as being functional by testing for a known cocrystal of theophylline and p-nitro phenol.

One to three slides were prepared for each guest compound. A spatula of guest compound was placed on the slide and melted with a heat gun or the hotstage. Two large drops of a preheated solution of theophylline in ethylene glycol were placed 1 cm from the guest and both drops were covered with a large coverslip. The boundary where the solutions merged was examined under a stereo microscope using transmitted light and crossed polars. The eutectic was cycled by heating and cooling in order to help detect and promote cocrystal formation. Salicylic acid, p-hydroxybenzoic acid, sorbic acid, 1-hydroxy-2-naphthoic acid, glycolic acid, and 2,5-dihydroxybenzoic acid were all tested as guest compounds and in each, a cocrystal formation had occurred. Raman spectra of the pure guest acid, theophylline, and the cocrystal were obtained and compared to confirm cocrystal formation.

What is claimed is:

1. A method for screening a cocrystal of an active agent and a guest comprising the steps of:
a. Contacting the active agent with a suitable liquid to form an active-agent solution;
b. Contacting the active-agent solution with a guest solution to form a mixture of solutions in an interface region;
c. Solidifying the solution mixture in the interface region to form a solid;
d. Analyzing the solid for the presence of a cocrystal.

2. The method of claim 1 wherein the analysis is performed by observing the formation of eutectic regions on both sides of the cocrystal in the interface region.

3. The method of claim 1 wherein the solidification occurs by lowering the temperature of the interface region mixture.

4. The method of claim 1 wherein the guest solution is a melt of the guest.

5. The method of claim 1 wherein the guest solution is prepared by contacting the guest with a suitable liquid.

6. The method of claim 5 wherein the suitable liquid contacted with the active agent is the same as that which is contacted with the guest.

7. The method of claims 1, 5, or 6 wherein the suitable liquid has a higher boiling point than the melting point of the active agent.

8. The method of claims 5 or 6 wherein the suitable liquid has a higher boiling point that the melting point of the guest.

9. The method of claim 1 wherein the analytical technique is selected from optical microscopy, x-ray powder diffraction, single-crystal x-ray analysis, Raman spectroscopy, Raman microscopy, and infrared spectroscopy.

10. A method for preparing a cocrystal of an active agent and a guest comprising the steps of:
a. Contacting the active agent with a suitable liquid to form an active-agent solution;
b. Contacting the active-agent solution with a guest solution to form a mixture of solutions in an interface region;
c. Solidifying the solution mixture in the interface region to form a cocrystal.
